(19) United States
(12) Patent Application Publication
(10) Pub. No.: US 2013/0246199 A1
(43) Pub. Date: Sep. 19, 2013

(54) POINT-OF-TRANSACTION ACCOUNT FEATURE REDIRECTION APPARATUSES, METHODS AND SYSTEMS

(71) Applicant: Mark Carlson, Half Moon Bay, CA (US)

(72) Inventor: Mark Carlson, Half Moon Bay, CA (US)

(21) Appl. No.: 13/802,465

(22) Filed: Mar. 13, 2013

Related U.S. Application Data
(60) Provisional application No. 61/610,534, filed on Mar. 14, 2012.

(51) Int. Cl. G06Q 20/20

(52) U.S. Cl. CPC G06Q 20/20
USPC 705/16

(57) ABSTRACT

The POINT-OF-TRANSACTION ACCOUNT FEATURE REDIRECTION APPARATUSES, METHODS AND SYSTEMS (“PTR”) transform point-of-transaction account feature user preference and payment account inputs using PTR components into redirected transaction and preference triggers. In some implementations, the disclosure provides a processor-implemented method of transforming user preference values into transaction account identifier values for increasing transaction processing efficiency and reducing repetitive data exchanges between merchants and consumers.

### PRIORITY CLAIM

This application is a non-provisional of and claims priority under 35 USC §119 to: U.S. provisional patent application Ser. No. 61/610,534 filed Mar. 14, 2012, entitled “POINT-OF-TRANSACTION ABSTRACTED REDIRECTION APPARATUSES, METHODS AND SYSTEMS,” attorney docket no. P-42252PRV|VISA-121/01US.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

The entire contents of the aforementioned application(s) are expressly incorporated by reference herein.

### FIELD

The present inventions are directed generally to apparatuses, methods and systems for account feature transaction processing, and more particularly, to POINT-OF-TRANSACTION ACCOUNT FEATURE REDIRECTION APPARATUSES, METHODS AND SYSTEMS (“PTR”).

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Consumers use credit cards. Credit cards have personal account numbers (PANs) that identify the consumer account. Merchants have accounts for consumers as well. Consumers often use card-based transactions (e.g., credit, debit, prepaid cards, etc.) to obtain products and services.

### BRIEF DESCRIPTION OF THE DRAWINGS

The accompanying appendices and/or drawings illustrate various non-limiting, example, innovative aspects in accordance with the present descriptions:

FIG. 1 shows a block diagram illustrating example aspects of point-of-transaction account feature redirection usage, in some embodiments of the PTR;

FIG. 2 shows a block diagram illustrating example aspects of point-of-transaction account feature redirection, in some embodiments of the PTR;

FIG. 3 shows a data flow diagram illustrating an example procedure for point-of-transaction account feature redirection, in some embodiments of the PTR;

FIGS. 4A-C show logic flow diagrams illustrating example aspects of tokenized PAN with embedded preferences creation, in some embodiments of the PTR;

FIG. 5 shows a logic flow diagram illustrating example aspects of processing merchant readable PAN preferences, in some embodiments of the PTR;

FIG. 6 shows a logic flow diagram illustrating example aspects of processing embedded consumer preferences, in some embodiments of the PTR;

FIGS. 7A-C show logic flow diagrams illustrating example aspects of post transaction engagement trigger processing, in some embodiments of the PTR;

FIGS. 8A-F show data flow diagrams illustrating an example procedure for point-of-transaction account feature redirection in some embodiments of the PTR;

FIGS. 9A-F show logic flow diagrams illustrating example aspects of point-of-transaction account feature redirection in some embodiments of the PTR, e.g., a Point-of-Transaction Account Feature Redirection (“PTR”) component 900;

FIG. 10 shows a logic flow diagram illustrating example aspects of analyzing a user's behavior based on aggregated purchase transaction data in some embodiments of the PTR, e.g., a User Behavior Analysis (“UBA”) component 1000;

FIG. 11 shows a logic flow diagram illustrating example aspects of generating recommendations for a user based on the user's prior aggregate purchase transaction behavior in some embodiments of the PTR, e.g., a User Behavior-Based Offer Recommendations (“UBOR”) component 1100;

FIGS. 12A-B show user interface diagrams illustrating example aspects of account feature redirection tokenized PAN creation, in some embodiments of the PTR;

FIGS. 13A-B show block diagrams illustrating example PAN tokenization with fixed and variable length preferences, in some embodiments of the PTR;

FIGS. 14A-B show user interface diagrams illustrating example aspects of dynamic user selection of virtual wallet transaction-related customizations in some embodiments of the PTR; and

FIG. 15 shows a block diagram illustrating embodiments of a PTR controller.

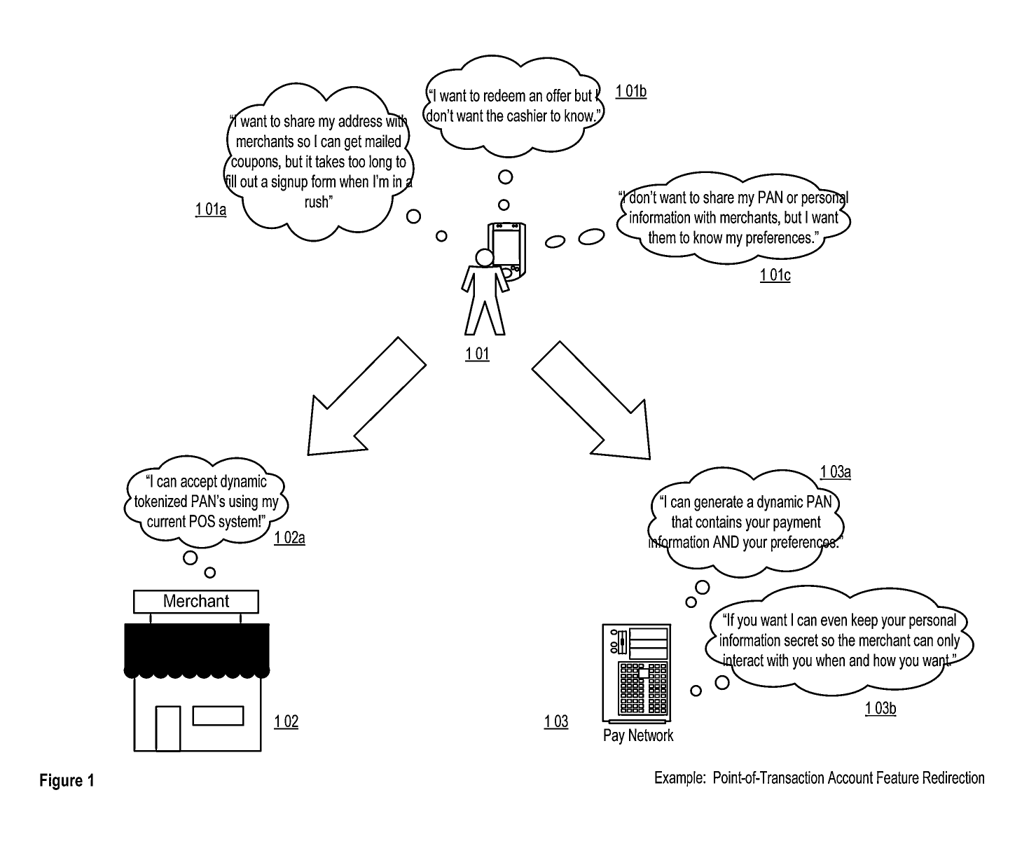

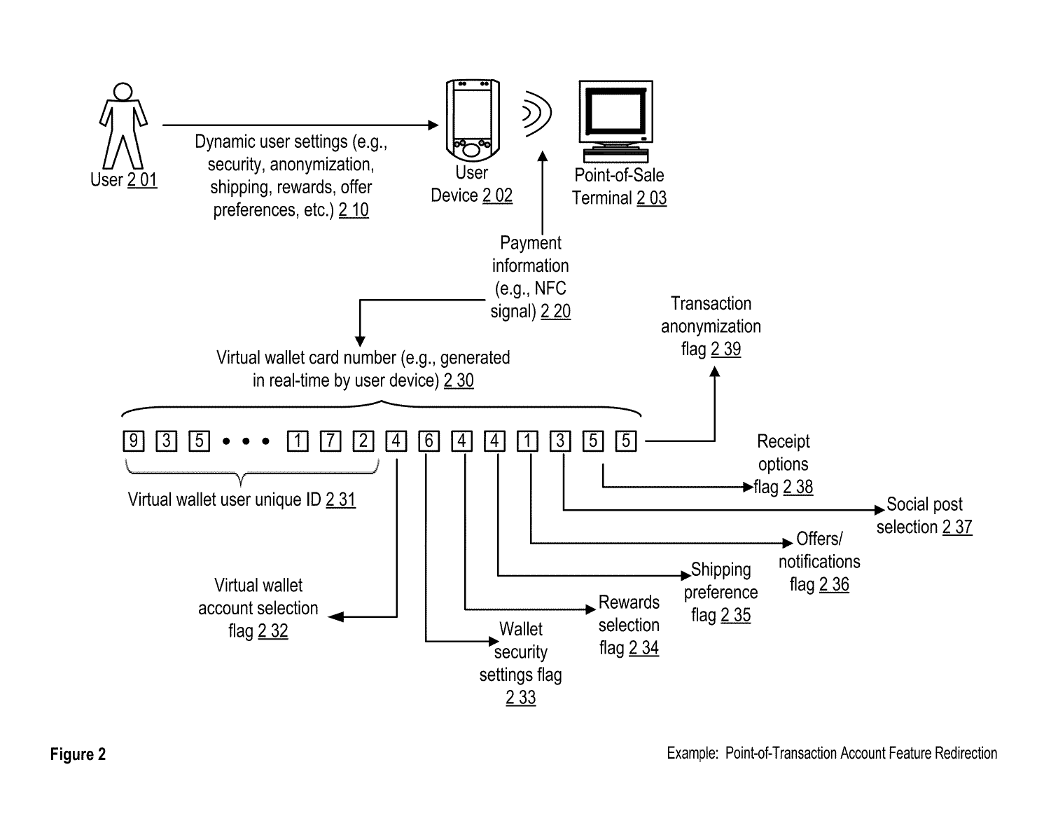

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION PTR

The POINT-OF-TRANSACTION ACCOUNT FEATURE REDIRECTION APPARATUSES, METHODS AND SYSTEMS (hereinafter “PTR” user interface) transform account feature redirected preference virtual wallet purchase settings, via PTR components, into real-time point-of-transaction account feature loyalty rewards offers. In some embodiments, this is carried out in real time.

FIG. 1 shows a block diagram illustrating example aspects of point-of-transaction account feature redirection usage, in some embodiments of the PTR. In one embodiment, a consumer 101 may wish to engage in a transaction with a merchant 102 while not revealing certain information to the merchant. For example, the consumer may want to share their address with the merchant in a manner that lets them complete their transaction quickly, e.g., 101a. In another embodiment, a consumer may want to redeem an offer but not want the cashier to know the consumer is doing so, e.g., 101b. In still other embodiments, the consumer may not want to share their account number, PAN, eWallet identifier, and/or the like with a merchant, but would like the merchant to be aware of certain preferences the consumer has, e.g., 101c. Preferences may be preferences in information sharing (e.g., address sharing, name sharing, device identifier sharing, location sharing, and/or the like), offer preferences (e.g., offer frequency preferences, offer type preferences, and/or the like), payment account preferences (e.g., default payment accounts, balance based payment account selectors, and/or the like), and/or the like. In some embodiments, a pay network server 103 may generate a dynamic number (e.g., a PAN number suitable for use in existing merchant payment processing infrastructure, a dynamic virtual wallet based identifier, and/or the like) that communicates both a payment account an one or more consumer preferences to a merchant, e.g., 103a. In another embodiment, the pay network may allow a consumer to keep their personal information secret so that the merchant may only interact with the consumer in the manner the consumer prefers (e.g., time limited interaction preferences, contact frequency preferences, and/or the like), e.g., 103b. In one embodiment, the merchant 102 may accept an identifier generated by pay network 103 using an existing POS system and payment infrastructure, e.g., 102a. In so doing, the merchant may process transactions containing multiple pieces of information by the exchange of account feature redirected identifiers. In so doing, transaction processing may be accelerated in so far as the merchant is able to gather multiple preferences and an account number from a consumer desiring to share same in a more efficient manner.

FIG. 2 shows a block diagram illustrating example aspects of point-of-transaction account feature redirection in some embodiments of the PTR. In some implementations, a user, e.g., 201, may desire to purchase products, services and/or other offerings (“products”) at a point-of-sale terminal, e.g., 203. For example, the point-of-sale terminal may be located within a brick-and-mortar merchant store, or may be a display for an online shopping site. In some implementations, the user may utilize a user device to initiate a purchase transaction at the point-of-sale terminal. For example, the user device may communicate with the point-of-sale terminal via transmitting signals via near-field communication (“NFC”) signals, Bluetooth, Wi-Fi, cellular communication, and/or the like. In some implementations, the user device may provide user payment information to the point-of-sale terminal via the transmitted signal. The payment information may include data such as, but not limited to: account number, name, digital certificate, privacy payment token, and/or the like. In some implementations, the user device of the user may be linked to a virtual wallet account of the user. In such implementations, the payment information provided by the user device to the point-of-sale terminal may embody information about the user's virtual wallet. Further, in some implementations, the payment information may include various user-selected options, such as, but not limited to: virtual wallet account selection (e.g., in the case of a virtual wallet handling multiple accounts/types for the user) 232, wallet security settings 233, transaction privacy/anonymization preferences 239, shipping preferences 235, allocation of rewards points stemming from the transaction to rewards account (and/or usage of existing rewards points of the user for payment of the purchase transaction) 234, real-time offers/notifications 236, posting of information on the user transaction to social media (e.g., providing a post to Facebook®, RightCliq™, Twitter™, etc.) 237, purchase receipt delivery options 138, and/or the like.

In some implementations, such user settings may advantageously be encoded into a virtual wallet card number that is generated on the fly in real-time by the user device, based on user selection of various such settings. For example, in some implementations, the user device may generate a virtual wallet card number that resembles (e.g., in data length) a traditional credit/debit card number (e.g., is of the same length as a debit/credit card number), but encodes a unique virtual wallet user identifier, e.g., 231, as well as user selections of various settings regarding the transaction and transaction-related events. Thus, in some implementations, the PTR may facilitate even a legacy point-of-sale terminal to operate on a real-time-generated virtual wallet card number (which encodes dynamic user settings at the point-of-sale) in a manner similar to a traditional card number associated with a credit/debit card, while providing the user-selected options to a payment network or payment gateway where the user preferences may be extracted to provide user-selected value-added services layered on top of the purchase transaction processing. In some implementations, such value added services may be implemented in the PTR as an additional application layer (“gateway abstraction layer”) implemented on a server of a payment network, or as a payment gateway server that may process the value-added services selection by the user and redirect the underlying purchase transaction to an appropriate payment network (e.g., Visa, American Express, Mastercard, Discover, etc.).

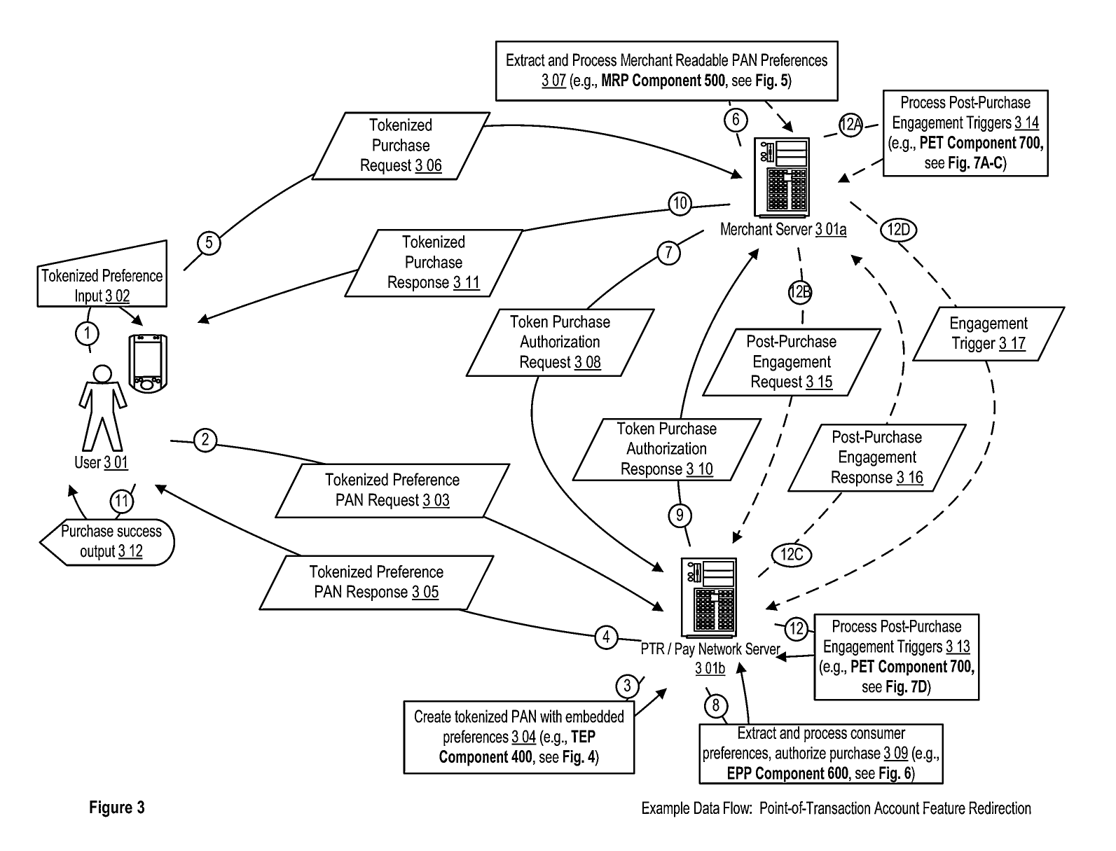

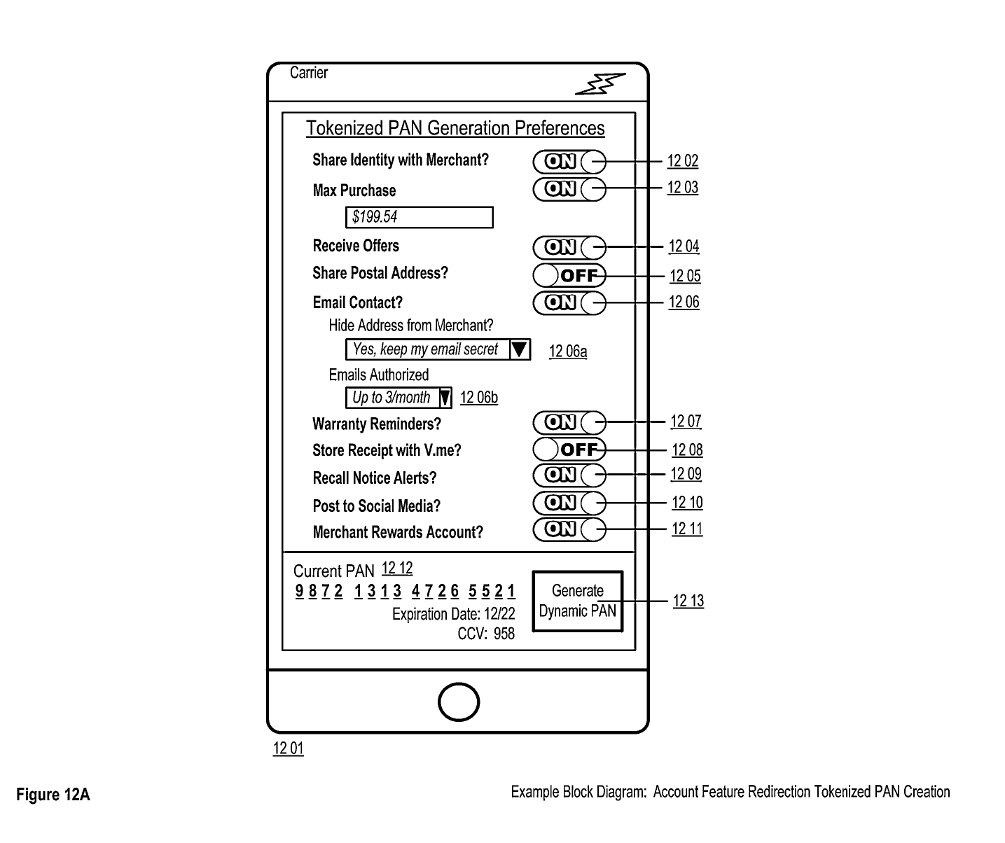

FIG. 3 shows a data flow diagram illustrating an example procedure for point-of-transaction account feature redirection, in some embodiments of the PTR. In one embodiment, user 301 inputs tokenized preference input 302 into a mobile device. Tokenized preference input may be collected using a mobile device based user interface such as that described with respect to FIGS. 12A-B and related descriptions. In one embodiment, the user's mobile device may generate a tokenized preference PAN request 303 and transmit same to a pay network server 301b to generate a preference encoded account feature payment identifier. The generated payment identifier may be in the form of a PAN that is substantially in the form of a valid credit or debit card number suitable for use on a pay network such as Visa©. In some embodiments, the PAN may be a non-standard length or take another form (e.g., an NFC transmittable token, an encoded series of visual flashes on the user device, an audio signal from the user's mobile device, and/or the like) as described further herein.

An example tokenized preference PAN request 303, substantially in the form of an HTTP(S) POST message including XML-formatted data, is provided below:

```
POST /tokenized_preference_pan_request.php HTTP/1.1
Host: www.paynetworkserver.com
Content-Type: Application/XML
Content-Length: 667
<?XML version = ″1.0″ encoding = ″UTF-8″?>
<tokenized_pref_pan_req>
  <timestamp>2011-12-12 15:22:43</timestamp>
  <auth>
    <user_id>7654353</user_id>
    <password>secretpass</password>
    <device_id type=”iPhone5”>E76565</device_id>
    <user_info>
      <name>John Consumer</name>
      <email>john.consumer@foo.com</email>
      <phone>645-123-4567</phone>
    </user_info>
    <key>
      TRDTRBKJHujJHG&\hat{ }%BKJBJHVTYEXERJHG
      VXDHJVRTDERJUHYLOPOOIUCFGWFDGFTRTD
      )TRDREWQTFRGCDYUG{UYTFTYDFGRERSEW%
    </key>
  </auth>
  <payment_account>
    <account_id>6548124821</account_id>
    <account_name>Business Visa Card</account_name>
    <account_num>2444555566667777</account_num>
    <exp_date>02-2025</exp_date>
    <current_balance>$564.67</current_balance>
  </payment_account>
  <dynamic_pan_to_generate>
    <characteristics>
      <pan_length unit=”slots” val=”16” />
      <pan_type val=”integer_stream” />
      <valid_for_only>
        <merchant>
          <name>Starbucks</name>
          <loc>1000 42nd Street, New York, NY 10001</loc>
          <geo lat=”23.8768768” lon=”2.5765765”
              aisle=”5” shelf=”24” />
        </merchant>
        <purchase>
          <max_purchase unit=”USD” val=”9.34” />
          <type group=”food” value=”coffee” />
        </purchase>
        <time_until_expire join=”OR”>
          <until type=”purchase_event” val=”authorize” />
          <until type=”time_limited” val=”1 hour” />
        </time_until_expire>
      </valid_for_only>
    </characteristics>
    <funding_from>
      <account_id>6548124821</account_id>
      <backup_account_id>98555555</backup_account_id>
    </funding_from>
    <user_preferences_to_encode>
      <user count=”1” id=”45454” name=”John Consumer”>
        <associated_suborder_items>
          <item1 price=”2.99” id=”VL543”>Vanilla Latte</item1>
        </associated_suborder_items>
        <pref type=”share_email” value=”true”>
          <option name=”hide_email” value=”true” />
          <option name=”max_contacts” value=”10” />
          <option name=”contact_freq” value=”1_per_week_max” />
        </pref>
        <pref type=”associate_payment_with_merch” value=”true”>
          <account value=”current_dynamic_pan” />
          <make_persistent value=”true” />
          <auto_auth_future value=”true” />
        </pref>
        <pref type=”merchant_rewards_account”>
          <signup_if_not_member value=”true” />
          <auto_credit_future_trans value=”true” />
        </pref>
        <pref type=”post_to_social_media” service=”facebook”>
          <fb_api_key value=”12154548” />
          <user_name value=”john.consumer@foo.com” />
          <password value=”mysecretfbpass” />
          <msg replace_val=”[thing],[amt]” with=”item,total”>
            I just bought a [thing] at Starbucks © for [amt]!
          </msg>
        </pref>
        <pref>
          ...
        </pref>
      </user>
      <user count=”2” id=”32553” name=”Jane Donoley”>
        <associated_suborder_items>
          <item1 price=”4.58” id=”ML322”>Mocha Latte</item1>
        </associated_suborder_items>
        <pref type=”share_identity” value=”true” />
        <pref type=”offers_opt_in” value=”false” />
        <pref type=”share_postal_address” value=”false” />
      </user>
      <user>
        ...
      </user>
    </user_preferences_to_encode>
    <merchant_to_transmit_to>
      <method_of_transmit>
        <primary type=”NFC” />
        <secondary type=”QRcode” />
        <backup type=”out_of_band_cellular” />
        <backup type=”queued_delayed_transmission” />
      </method_of_transmit>
      <merchant>
        <name>Starbucks</name>
        <loc>1000 42nd Street, New York, NY 10001</loc>
        <geo lat=”23.8768768” lon=”2.5765765”
            aisle=”4” shelf=”7” />
      </merchant>
    </merchant_to_transmit_to>
  </dynamic_pan_to_generate>
</tokenized_pref_pan_req>
```

In one embodiment, the pay network server 301b may then generate a tokenized PAN with embedded user preferences. Further detail regarding tokenized PAN with embedded preferences creation and usage may be found with respect to FIGS. 134A-C, e.g., TEP Component 400. In one embodiment, the pay network server may then respond with a tokenized preference PAN response containing the generated preference PAN information. An example tokenized preference PAN response 305, substantially in the form of an HTTP(S) POST message including XML-formatted data, is provided below:

```
POST /tokenized_preference_pan_response.php HTTP/1.1
Host: www.paynetworkserver.com
Content-Type: Application/XML
Content-Length: 667
<?XML version = ″1.0″ encoding = ″UTF-8″?>
<tokenized_pref_pan_response>
  <generated_for>
    <user_id>7654353</user_id>
    <user_info>
      <name>John Consumer</name>
      <email>john.consumer@foo.com</email>
      <phone>645-123-4567</phone>
    </user_info>
  </generated_for>
  <auth>
    <api_key>EGVJHVBGUYTTY</api_key>
    <certificate_hash method=”sha256”>
        kkjhiUY&\hat{ }%87675drtfytf
    </certificate_hash>
  </auth>
  <generated_dynamic_pref_pan>
    <number value=”4212 3456 7890 1234” />
    <exp_date value=”01-23” />
    <billing_address>
      <addr>500 Main St.</addr>
      <city>Anytown</city>
      <state>CA</state>
      <zip>91123</zip>
    </billing_address>
    <characteristics>
      <pan_length unit=”slots” val=”16” />
      <pan_type val=”integer_stream” />
      <valid_for_only>
        <merchant>
          <name>Starbucks</name>
          <loc>1000 42nd Street, New York, NY 10001</loc>
          <geo lat=”23.8768768” lon=”2.5765765”
              aisle=”7” shelf=”24”/>
        </merchant>
        <purchase>
          <max_purchase unit=”USD” val=”9.34” />
          <type group=”food” value=”coffee” />
        </purchase>
        <time_until_expire join=”OR”>
          <until type=”purchase_event” val=”authorize” />
          <until type=”time_limited” val=”1 hour” />
        </time_until_expire>
      </valid_for_only>
    </characteristics>
  </generated_dynamic_pref_pan>
</tokenized_pref_pan_response>
```

In some embodiments, the generation of the tokenized preference PAN may take place completely on a user's device. In some examples, the user device may pre-cache required generation values (e.g., available time-limited PAN slots, account numbers, preference default settings, previously used preference values and/or the like) so as to be able to generate a tokenized PAN without requiring proximal communication with a pay network server. In still other embodiments, a user device may receive a dynamic tokenized preference PAN rule set that is suitable for the generation of a multiplicity of PAN's over time. In even further embodiments, a user device may communicate with a third party server (e.g., a merchant server 301a, a personal private cloud server, and/or the like) in order to generate tokenized preference PAN's.

In one embodiment, the user's mobile device may then create a tokenized purchase request and transmit same to merchant server 301a in order to effect a tokenized preference purchase. In one embodiment, the user device may further manipulate the tokenized preference pan response 305 before preparing the tokenized purchase request 306 (e.g., to add additional preferences not communicated to pay network server 301b, to remove preferences, to alter previously encoded preferences, to adjust the time a PAN may be active, and/or the like). In one embodiment, the tokenized purchase request 306 may contain order information (e.g., products requested, quantity, shipping information, and/or the like).

An example tokenized purchase request 306, substantially in the form of an HTTP(S) POST message including XML-formatted data, is provided below:

```
POST /tokenized_purchase_request.php HTTP/1.1
Host: www.merchantserver.com
Content-Type: Application/XML
Content-Length: 667
<?XML version = ″1.0″ encoding = ″UTF-8″?>
<tokenized_purchase_req>
  <auth>
    <user_id>21484784</user_id>
    <password>secretpass</password>
    <user_info>
      <name>John Consumer</name>
      <email>john.consumer@foo.com</email>
      <phone>645-123-4567</phone>
    </user_info>
    <public_key>
      984k&43VHYTG*&\hat{ }DTRFGBJHNKUHYTGR
      MKFCCFGHUHUJhtE%$\hat{ }FYTGBJVHKIHY
      MLUYTRFDTRDDJJHVGFTYCFRTKJBNIKU
    </public_key>
  </auth>
  <payment_account>
    <dynamic_pan_generated value=”4212 3456 7890 1234” />
    <exp_date value=”01-23” />
    <billing_address>
      <addr>500 Main St.</addr>
      <city>Anytown</city>
      <state>CA</state>
      <zip>91123</zip>
    </billing_address>
  </payment_account>
</tokenized_purchase_req>
```

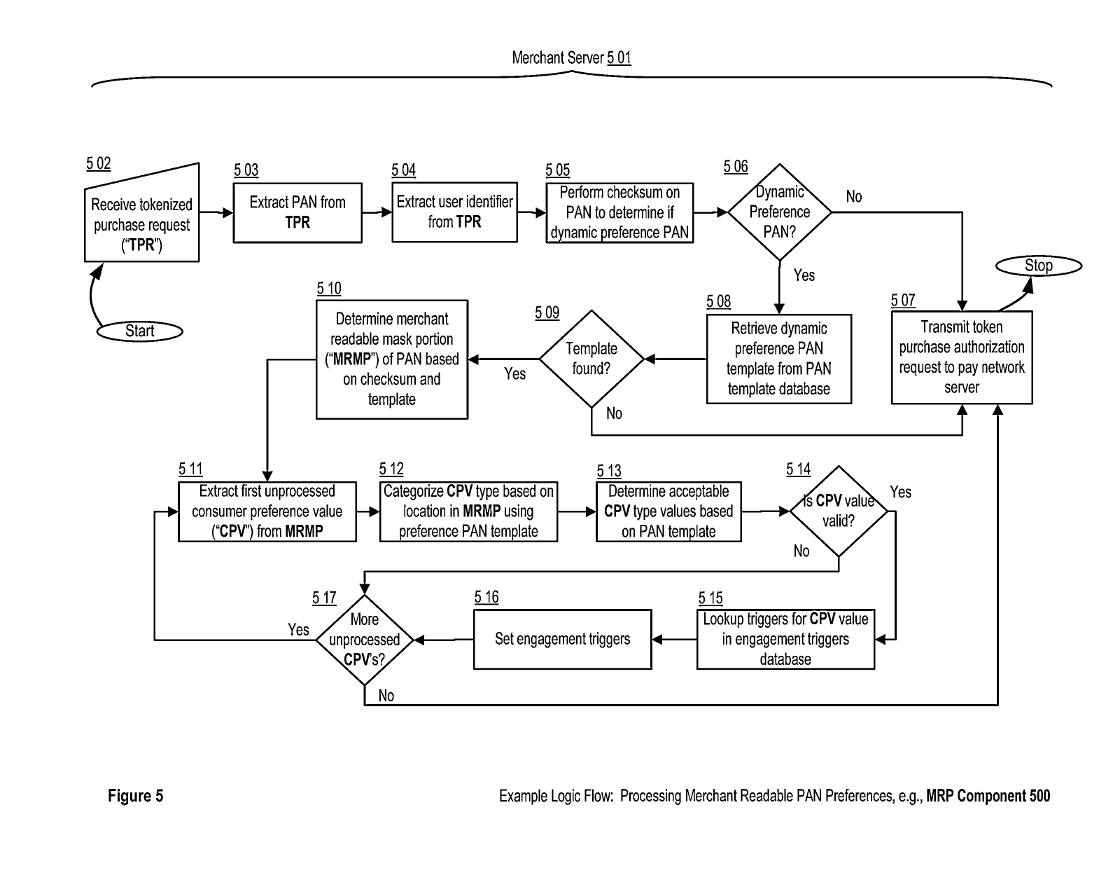

In one embodiment, merchant server 301 may then extract and process any portions of the tokenized purchase request 306 that are suitable for communicating consumer preferences, e.g., 307. In one embodiment, the generated tokenized preference PAN may be mapped to a template to determine the portions of the PAN that are readable by the merchant as well as how to interpret the values. Such a template may be provided by a third-party server (e.g., a pay network server 301b, another merchant server, and/or the like). In one embodiment, all preference values encoded in the dynamic tokenized PAN may be read by the merchant. In other embodiments, only a subset of consumer preference values may be decoded by the merchant. In still other embodiments, no merchant readable preference values may be present in the generated tokenized preference PAN. In some embodiments, the merchant may be able to determine whether consumer preferences are encoded in a PAN by performing a manipulation on the PAN (e.g., via a checksum function and/or the like) Further detail regarding the extracting and processing of merchant readable PAN preferences may be found with respect to FIG. 5, e.g., an MRP Component 500. Based on the consumer preferences that a merchant extracts from the tokenized purchase request 306, engagement triggers may be set on the merchant server or elsewhere in order to take advantage of the consumer's preference settings. For example, if a consumer indicates by a merchant readable preference setting in their tokenized PAN that they wish to receive offers from the merchant, the merchant server 301a may create a trigger to periodically search an offers database for currently active offers and forward an appropriate offer to the consumer based optionally on his/her purchase history with the merchant. In another example, if a consumer indicates in a merchant readable preference that they wish to receive direct mail from the merchant, the merchant may create a trigger to mail the consumer coupons at the address the merchant has on file. In still other embodiments, the merchant may not have sufficient information to process a consumer's preference. For example, a merchant may not have a consumer's home address. In one embodiment, the merchant server may then set a trigger to obtain the required information from a third-party source (e.g., from pay network server 301b, via a publicly searchable address database, by sending a text message to the consumer's phone soliciting their address, and/or the like). In still other embodiments, a merchant server may set a trigger to obtain the information directly from the consumer at a later time (e.g., by alerting a sales clerk that the consumer has opted in for address collection the next time the consumer makes a purchase at the merchant's store, by prompting the consumer of their preference the next time consumer visits the merchant's web site, and/or the like).

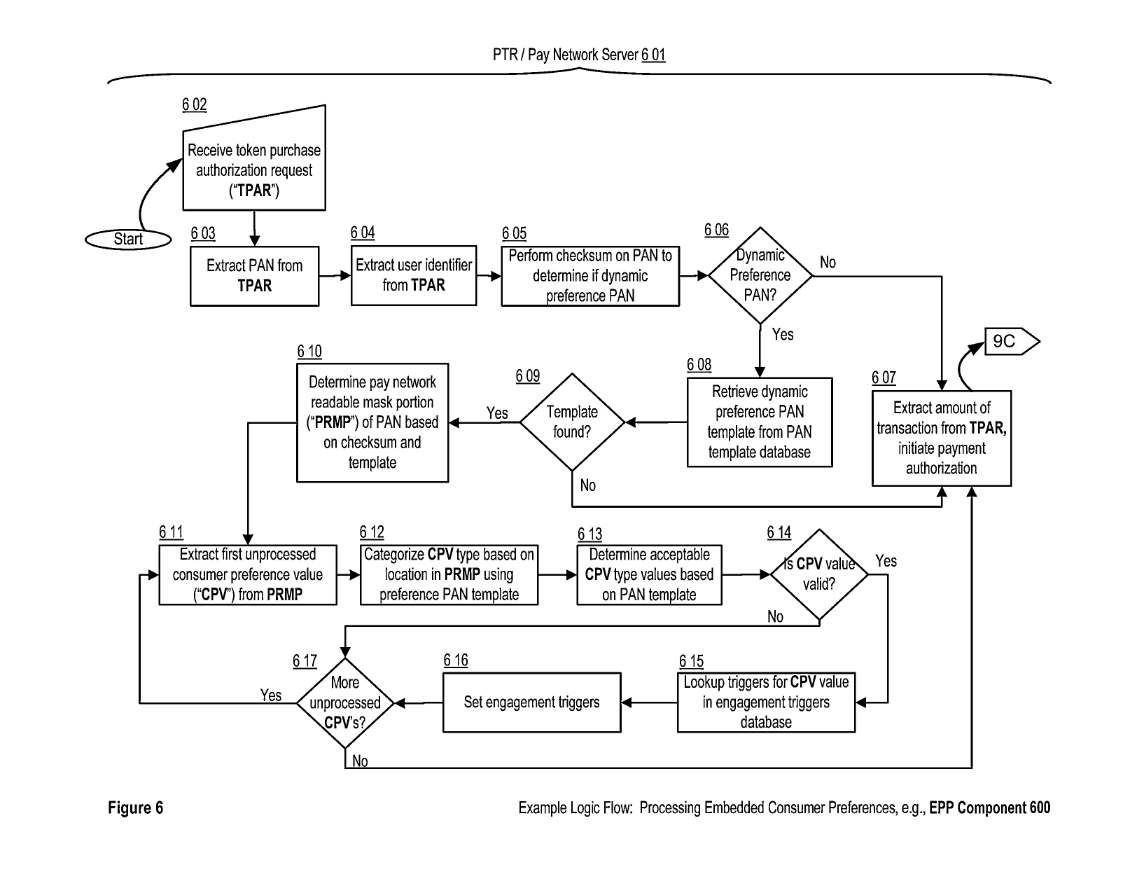

In one embodiment, merchant server may forward the tokenized purchase request 306 to pay network server 301b for transaction processing, consumer preference extraction, trigger setting, and/or the like, e.g., 308. In some embodiments, the merchant server may alter or change the purchase authorization request (e.g., reformat the request as required by pay network, increase authorization request values, indicate that some consumer preferences have been processed, and/or the like). In one embodiment, portions of the purchase authorization request may be routed on top of an ISO8535 authentication request (e.g., as a 64-bit or n-bit message over a payment network, and/or the like) while other portions may be communicated to the merchant or pay network server through an out-of-band communication over a different channel (e.g., via a TCP/IP stack connection, via dedicated fiber line, and/or the like). The pay network server 301b may extract and process consumer preferences and authorize the purchase 309. Further detail regarding the extraction and processing of consumer preferences and the authorization of tokenized purchases may be found with respect to FIG. 6, e.g., EPP Component 600.

In one embodiment, pay network server 301b may respond to the merchant server 301a with a token purchase authorization response 310. The response may contain information relating to the transaction authorization, consumer preference information, consumer information required by the merchant to process or act on consumer preferences, consumer preferences/triggers processed or set by pay network and/or the like.

An example token purchase authorization response 310, substantially in the form of an HTTP(S) POST message including XML-formatted data, is provided below:

```
POST /tokenized_purchase_auth_response.php HTTP/1.1
Host: www.merchantserver.com
Content-Type: Application/XML
Content-Length: 667
<?XML version = ″1.0″ encoding = ″UTF-8″?>
<token_purchase_auth_response>
  <auth>
    <merchant_id>878656464</merchant_id>
    <api_key>EGVJHVBGUYTTY</api_key>
    <certificate_hash method=”sha256”>
        kkjhiUY&\hat{ }%87675drtfytf
    </certificate_hash>
  </auth>
  <purchase currency=”USD” amount=”9.34”>
    <status>Approved</status>
    <status_code approved=”true”>500</status_code>
    <!-- extracted consumer preferences and consumer data
          may be sent to merchant -->
    <consumer_preferences>
      <user count=”1”>
        <purchased>
          <item1 price=”2.99”>Vanilla Latte</item1>
        </purchased>
        <!-- consumer data may be inline -->
        <pref type=”email” setTriggers=”merchant_side”>
          <method value=”hidden_contact_through_payNet” />
          <max_contacts value=”10” />
          <contact_freq value=”1_per_week_max” />
          <data>
            <email>hiddenconsumeraddress@paynetsrvc.com</email>
          </data>
        </pref>
        <!-- consumer data may be remote retrievable -->
        <pref type=”rewards_account” setTriggers=”merchant_side”>
          <method value=”create_account” />
          <data type=”remote_retrieve” />
            <remote_server>
              https://paynet.com/access/876876
            </remote_server>
            <fields_available>
              <field name=”consumer_name” />
              <field name=”consumer_email” />
              <field name=”consumer_phone” />
              <field name=”consumer_address” />
              <field name=”consumer_city” />
              <field name=”consumer_state” />
              <field name=”consumer_zip” />
              <field name=”consumer_purchase_history” />
            </fields_available>
        </pref>
        <!-- pay network server may process consumer preference
              triggers (e.g., post to social media, send direct
              mail, initiate email campaign followup on behalf
              of merchant, and/or the like) without sharing
              consumer data with merchant -->
        <pref type=”social_media_post” setTriggers=”payNet_side”>
          <status value=”SUCCESS” />
          <details>
            Pay Network posted purchase information to
            consumer's social media feed automatically
          </details>
        </pref>
        <pref type=”email_followup” setTriggers=”payNet_side”>
          <status>ACTIVE</success>
          <frequency value=”monthly” />
          <content value=”monthly_specials_campaign” />
          <content_source>
            <url>https://merch.com/monthly/current</url>
          </content_source>
          <merchant_updatable_content value=”true” />
          <merchant_view_consumer_email value=”false” />
          <merchant_can_unsub_consumer value=”true” />
          <details>
            Pay Network will email consumer a list of monthly
            specials automatically.
          </details>
        </pref>
        <pref>
          ...
        </pref>
      </user>
      <user>
        ...
      </user>
    </consumer_preferences>
  </purchase>
  <purchase>
    ...
  </purchase>
</token_purchase_auth_response>
```

In one embodiment, merchant server 301a may respond to user mobile device, e.g., 301, with a tokenized purchase response 311. The tokenized purchase response may indicate that the requested transaction has been authorized, preferences the user set have been processed, and/or the like. In one embodiment, the user's mobile device may display a purchase success output message 312 indicating that the preference based transaction has been successfully processed.

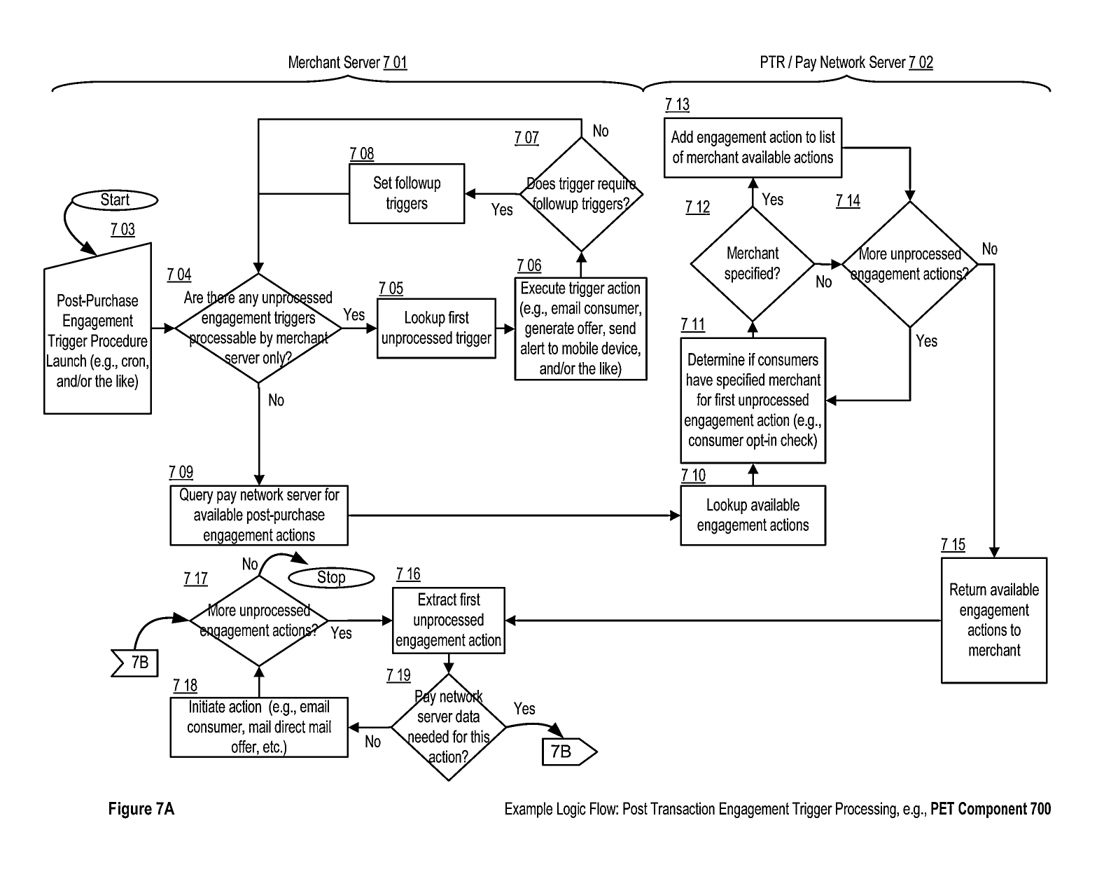

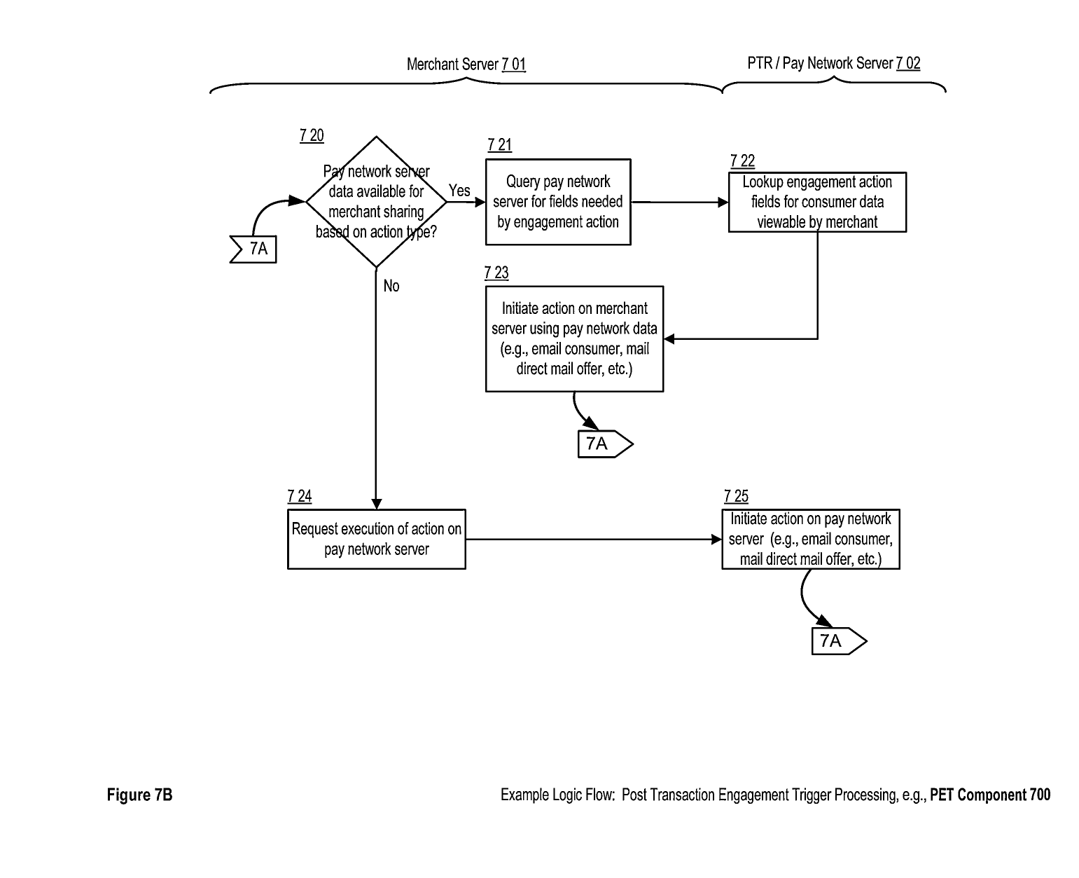

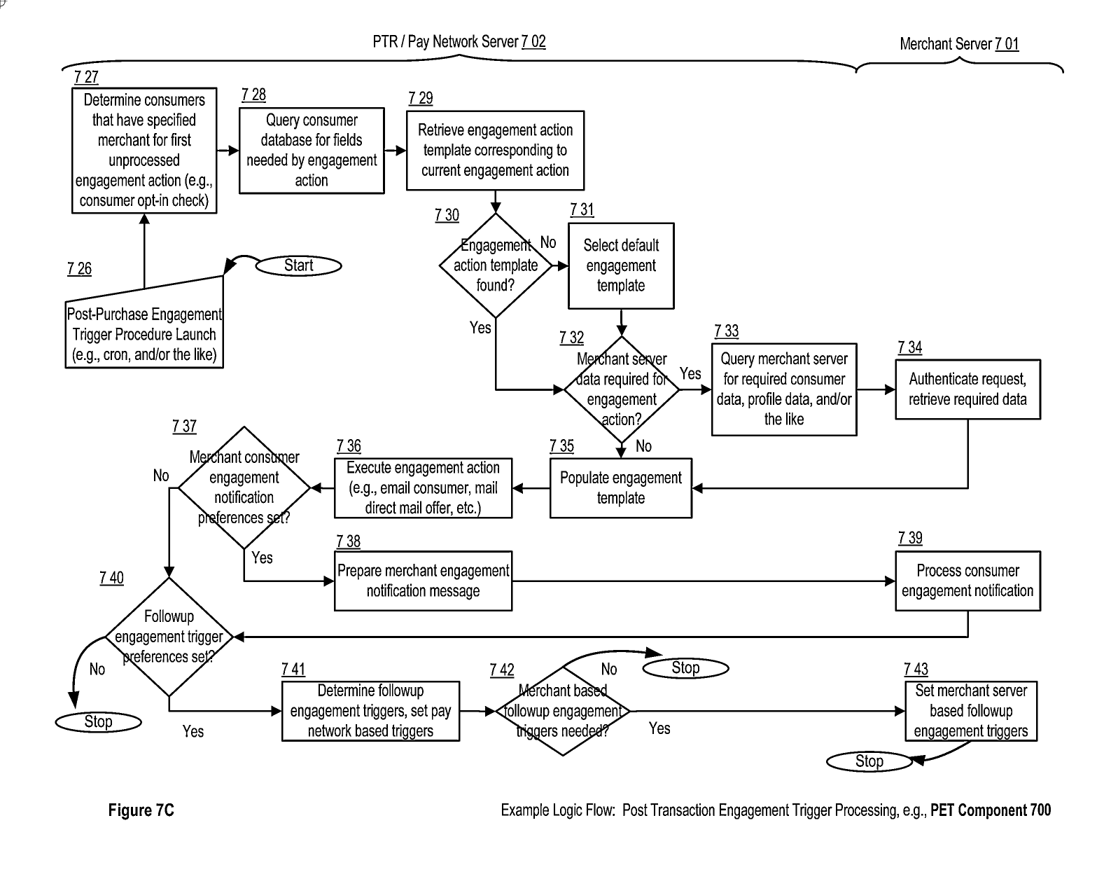

In one embodiment, pay network server 301b may the process triggers that were set as a result of the consumer's preferences, transaction details, and/or the like. For example, if a consumer opted in to receive periodic emails from the merchant managed by the pay network, a trigger may periodically run on the merchant server to retrieve the latest version of a newsletter from the merchant and email it to the consumer. In other embodiments, the pay network may process consumer preferences independently (e.g., without further intervention from merchant) and/or privately (e.g., without making merchant aware of consumer's preferences or the processing of preference triggers. Further detail regarding processing post-purchase engagement triggers 313 may be found herein and particularly with respect to FIG. 7D, e.g., PET Component 700.

In some embodiments, the processing of post purchase engagement triggers may initiate from merchant server 301a or another third-party server, e.g., 314. Further detail regarding merchant server based post-purchase engagement trigger processing may be found herein and particularly with respect to FIG. 7, e.g., PET Component 700. In some embodiments, merchant server 301a may, independently or in response to a post-purchase engagement trigger, solicit from pay network server a list of post-purchase engagement operations that the pay network server can support or has information regarding, e.g., 315. An example post-purchase engagement request 315, substantially in the form of an HTTP(S) POST message including XML-formatted data, is provided below:

```
POST /post_purchase_engagement_request.php HTTP/1.1
Host: www.merchantserver.com
Content-Type: Application/XML
Content-Length: 667
<?XML version = ″1.0″ encoding = ″UTF-8″?>
<post_purchase_engagement_request>
  <merchant id=”876876” name=”Starbucks on 42nd Street”>
  <auth>
    <merchant_id>878656464</merchant_id>
    <api_key>EGVJHVBGUYTTY</api_key>
    <certificate_hash method=”sha256”>
        kkjhiUY&\hat{ }%87675drtfytf
    </certificate_hash>
  </auth>
  <request type=”engagement_options_data />
</post_purchase_engagement_request>
```

The pay network server may reply with a post-purchase engagement response containing information regarding available services the pay network server may provide to merchant server 301a. An example post-purchase engagement response 316, substantially in the form of an HTTP(S) POST message including XML-formatted data, is provided below:

```
POST /post_purchase_engagement_response.php HTTP/1.1
Host: www.merchantserver.com
Content-Type: Application/XML
Content-Length: 667
<?XML version = ″1.0″ encoding = ″UTF-8″?>
<post_purchase_engagement_response>
  <status value=”success” />
  <engagements_available count=”3”>
    <engagement type=”email_consumers”>
      <subscribers number=”5214” />
      <last_action type=”email” value=”−4days” />
      <actions>
        <action type=”email_subscribers” />
        <action type=”view_subscribers status=”disabled” />
      </actions>
    </engagement>
    <engagement type=”managed_rewards_program”>
      <subscribers number=”13584” />
      <last_action type=”update_offers” value=”−30days” />
      <actions>
        <action type=”update_offers” />
        <action type=”email_members” />
        <action type=”retrieve_list_members” />
        <action type=”edit_member_profile” />
      </actions>
    </engagement>
    <engagement>
      ...
    </engagement>
  </engagements_available>
</post_purchase_engagement_response>
```

In one embodiment, merchant server may then set triggers to initiate engagement actions or initiate engagement actions immediately. In other embodiments, the merchant server may set an engagement trigger (e.g., send an email, initiate direct mail, and/or the like) on pay network server 301b by transmitting a message indicating the trigger and values to set, e.g., 317. An example engagement trigger 317, substantially in the form of an HTTP(S) POST message including XML-formatted data, is provided below:

```
POST /engagement_trigger.php HTTP/1.1
Host: www.paynetworkserver.com
Content-Type: Application/XML
Content-Length: 667
<?XML version = ″1.0″ encoding = ″UTF-8″?>
<engagement_trigger>
  <trigger id=”548” for_user_id=”458” type=”email_followup”>
    <process_time value=”immediately” />
    <email_subject>Monthly Specials for You!</email_subject>
    <content>
      You have not visited us recently! Click here to see
      our monthly specials.
    </content>
    <tracking_link value=”https://merch.com/track/KIHJH” />
  </trigger>
  <trigger id=”121” for_user_id=”773” type=”direct_mail”>
    <process_time value=”02-25-2020 12:14:54” />
    <content type=”template” value=”template436” />
  </trigger>
  <trigger>
    ...
  </trigger>
</engagement_trigger>
```

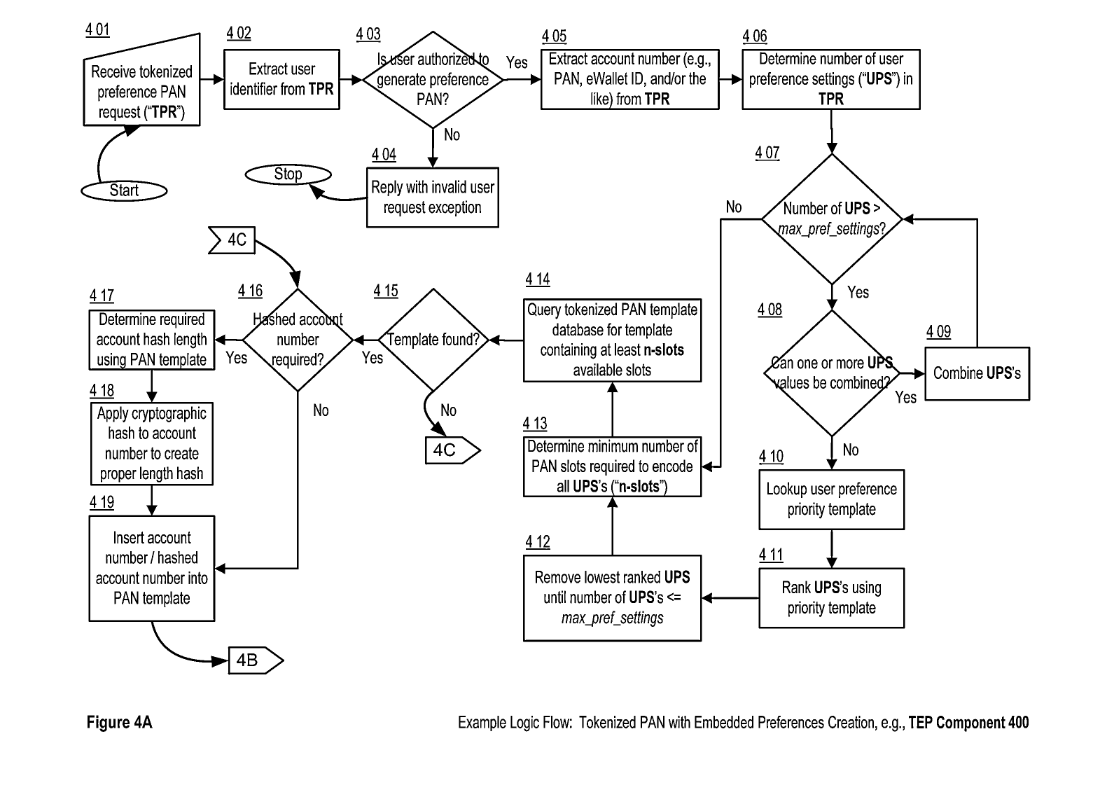

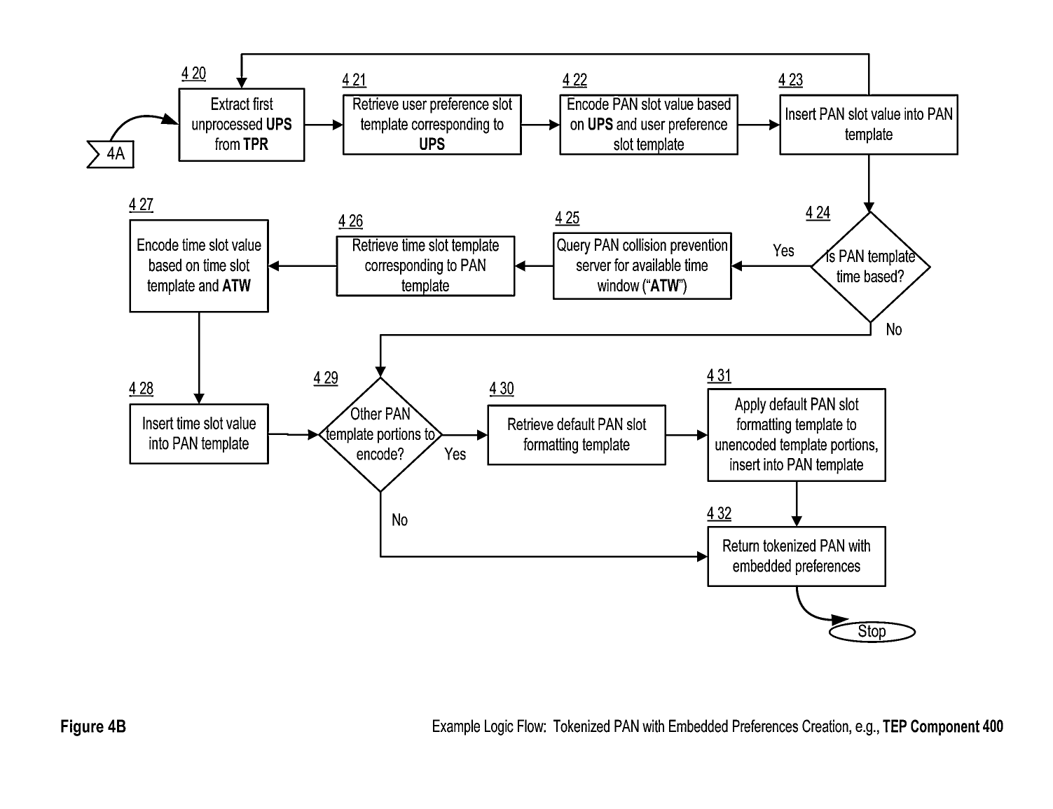

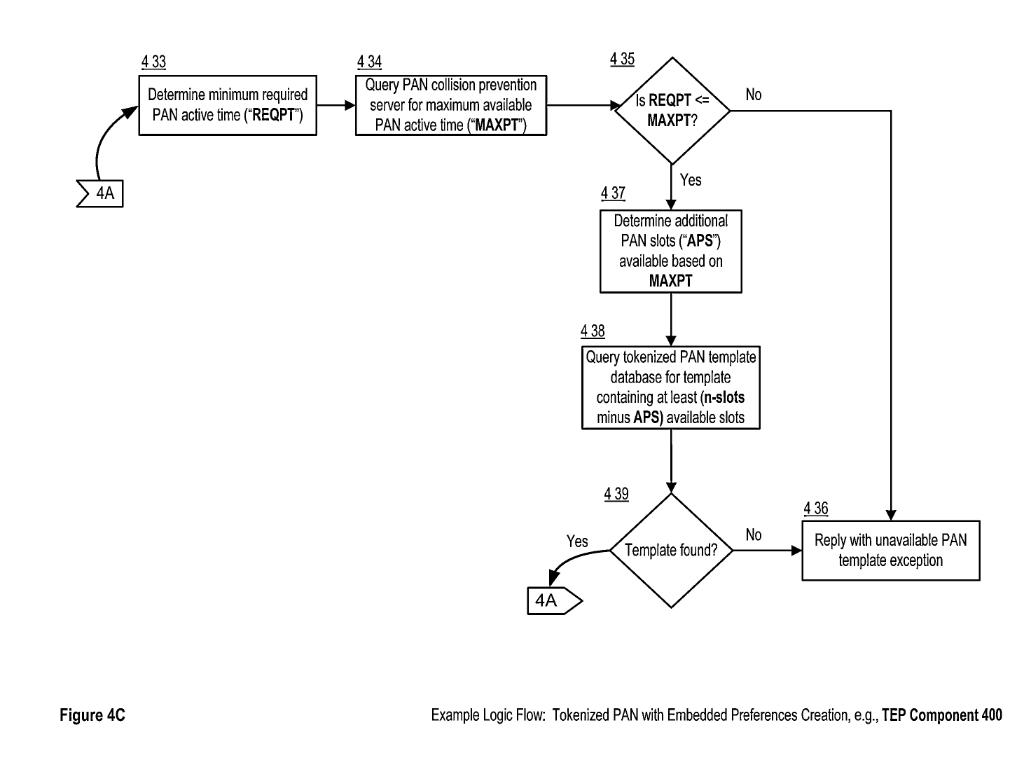

FIGS. 4A-C show logic flow diagrams illustrating example aspects of tokenized PAN with embedded preferences creation, in some embodiments of the PTR. In one embodiment, a tokenized preference pan request may be received 401. In some embodiments, the request may be received from a user device at a pay network server. In other embodiments, the request may initiate and be processed on the user device itself. In one embodiment, a user identifier is extracted 402 (e.g., a user ID, a PAN number, an account identifier, an email address, and/or the like). If the user is not authorized to generate a preference PAN, e.g., 403, an invalid user request exception may be raised, e.g., 404. In one embodiment, an account number (e.g., a PAN, a virtual wallet identifier, an email address, and/or the like) is extracted from the request, e.g., 405 and the number of user preference settings to be represented by the tokenized preference pan is read, e.g., 406. If the number of user preference settings is greater than the maximum allowable preference settings 407 (e.g., the maximum number that may be contained in the dynamic PAN given the requested PAN characteristics, the time the PAN must be active, business rules of the merchant or pay network, and/or the like). In one embodiment, user preference settings may be combined 408, 409. For example, if one preference setting implies another, the settings may be represented by a single preference and later inferred based on the implicit relationship. For example, if a consumer expressed a preference setting indicating that their name may be shared with a merchant and a preference setting indicating that the consumer does not want to remain anonymous, the setting indicating the name may be shared may be used to represent both settings since it is not feasible to share a consumer's name while also having the consumer remain anonymous.

In one embodiment, the number of preference settings may still be larger than the amount that may be represented in the desired tokenized dynamic PAN. If further preferences can not be combined, e.g., 408, a user priority preference template may be retrieved 410. The priority template may specify a user selected priority ranking or a default priority ranking. The preferences may be ranked using the template, e.g., 411, and the preferences with the lowest rank may be removed until the number of preferences is less than the maximum preference settings.

In one embodiment, the maximum number of space in a PAN required to represent the preferences may be determined 413. For example, two preferences with 5 values each may be represented in a single PAN digit with 10 possibilities (e.g., 0-9). Similarly, non-numeric values may be employed to further increase the number of preference values that may be stored. Combinations of PAN positions may also be employed to represent preferences (e.g., two slots may represent more than two preferences). In one embodiment, a tokenized PAN template database may be queried for a template containing at least the required number of slots, e.g., 414.

If a template is found, e.g., 415, a determination is made to see if a hashed account number is required, e.g., 416. For example, based on the number of preferences to be represented in a PAN, it may be determined that only 5 PAN slots are available to represent a payment account number with 16 digits. Similarly, if less preferences are required to be stored, more space may be available for an account number and no hash may be required. In one embodiment, if a PAN is only required to be active for a period of time then an even shorter account identifier may be used by taking advantage of time-limited PAN's, as described below.

In one embodiment, a hash length is determined based on the required slots available for representing an account identifier in the desired PAN template, e.g., 417. A cryptographic hash such as SHA-256, MD5, HAVAL, and/or the like may then be employed to create an account hash of the required length, e.g., 418, and the hash may be inserted into the PAN template, e.g., 419.

With respect to FIG. 4B, a first unprocessed user preference may be extracted from the tokenized preference pan request, e.g., 420. A template corresponding to the preference slot may be retrieved, e.g., 421. An example preference slot template, substantially in the form of XML is:

```
<preference_slot_template>
  <preference_type=”offer_preference” />
  <slots_required value=”2” />
  <merchant_readable value=”false” />
  <manipulation>
    <verify type=”is_value”>
      <valid id=”1” value=”opt_in_offers” />
      <valid id=”2” value=”no_offers” />
      <valid id=”3” value=”occasional_offers>
        <also_required value=”frequency_preference_value” />
      </valid>
    </verify>
    <apply type=”map_preference_value_to_id” />
  </manipulation>
  <slot_location startSlot=”7” endSlot=”8” />
</preference_slot_template>
```

In one embodiment, the PAN slot value is encoded based on the slot template, e.g., 422 and the encoded value is inserted into the PAN template, e.g., 423. If the PAN is time based 424 (e.g., only required to be active for a period of time, required to be time based by number of preference slots required, and/or the like), a PAN collision prevention server may be queried for a list of available time windows, e.g., 425. An example PAN collision prevention query 425, substantially in the form of PHP/SQL commands is provided below:

<?PHP
header(‘Content-Type: text/plain’);
mysql_connect(“localhost”,$DBserver,$password); // access
database server
mysql_select_db(“time_collission.sql”);
$query = “SELECT available_time_slice_start,
available_time_slice_end FROM pan_times WHERE
pan_active_time >=
$required_pan_time”;
$result = mysql_query($query); // perform the search query
mysql_close(“time_collission.sql”); // close database access
?>

An example PAN collision prevention query result, substantially in the form of XML is:

```
<available_pan_hashing_time_slices>
  <slice number=”1”>
    <active_time_available value=”600” />
    <pan_template_slots_needed value=”1” />
    <pan_prefix_to_use value=”7” />
    <encoding_function value=”SHA256” />
  </slice>
  <slice number=”2”>
    <active_time_available value=”70000” />
    <pan_template_slots_needed value=”5” />
    <pan_prefix_to_use value=”W” />
    <encoding_function value=”MD5” length=”5” />
  </slice>
</available_pan_hashing_time_slices>
```

In one embodiment, a time slot template is retrieved 426 and the available time slot is encoded based on the template 427 and inserted into the PAN template 428. If other portions of the PAN template still require population, e.g., 429, a default PAN slot formatting template may be retrieved 430 and applied to the unencoded portions, e.g., 431. In one embodiment, the default PAN slot formatting template removes and slots corresponding to the unencoded portions. In one embodiment, the tokenized PAN with embedded preferences may then be returned, e.g., 432.

With respect to FIG. 4C, if an appropriate template containing the required preference slots is not found, e.g., 415, a minimum required PAN active time may be determined 433. For example, if a consumer is requesting a preference encoded pan to make a purchase at a coffee shop, the active time required by the PAN may be less than if the consumer was pre-authorizing a large purchase such as a television. Similarly, PAN's used in restaurant environments often need to be active for longer periods given that the amount of the transaction authorized may change if the consumer adds a tip for their server. A PAN collision prevention server may be queried for the maximum available time a PAN may be active, e.g., 434. An example query/response may be substantially similar to the collision prevention query 425 as demonstrated above. In one embodiment, if the required PAN active time is less than or equal to the maximum available PAN active time, e.g., 435, additional slots may be made available for other users (e.g., encoding consumer preferences and/or the like). In one embodiment, the number of available slots is determined, e.g., 437. For example, if the PAN is only required to be active for one hour, a short three digit account identifier (or account identifier hash) may be used because the time server may allow other transaction authorizations to use a similar sized hash without fear of hash collision after the hour is expired (e.g., the same account identification hash being used by two different accounts). Additionally, a PAN modifier (e.g., a PAN prefix, suffix, and/or the like) may be used to further slice available time slots so as to avoid PAN has collision. In one embodiment, the additional PAN slots made available by using a time limited PAN may be subtracted from the required slots needed to represent a consumer's preferences (i.e., an acceptable PAN template may have less than the required number of preference slots because some of the slots designated for an account hash may be reclaimed and used for consumer preference encoding) and the PAN template database may be queried for an appropriate template, e.g., 438.

FIG. 5 shows a logic flow diagram illustrating example aspects of processing merchant readable PAN preferences, in some embodiments of the PTR. In one embodiment, a tokenized purchase request is received at a merchant server 501, e.g., 502. A tokenized preference PAN may be extracted from the tokenized purchase request, e.g., 503, and a user identifier may be similarly extracted, e.g., 504. A checksum operation, modulus operation (e.g., “$mod=$pan % 10;”), and/or the like may be performed on the extracted PAN, user identifier or other information in the tokenized purchase request in order to determine if the PAN contains consumer preferences, e.g., 505. In one embodiment, no check is done to determine if the PAN contains consumer preferences.

In one embodiment, if the PAN is a dynamic preference PAN containing consumer preferences, e.g., 506, a dynamic preference PAN template may be retrieved, e.g., 508. An example dynamic preference PAN template lookup query 508, substantially in the form of PHP/SQL commands is provided below:

<?PHP
header(‘Content-Type: text/plain’);
mysql_connect(“locaohost”,$DBserver,$password); // access
database server
mysql_select_db(“dynamic_pan_template.sql”);
$query = “SELECT template FROM pan_templates WHERE
pan_templates.matches LIKE ‘$mod’”;
$result = mysql_query($query); // perform the search query
mysql_close(“dynamic_pan_template.sql”); // close database access
?>

An example PAN template query response, substantially in the form of XML is:

```
<pan_template id=”584”>
  <matches>
    <pan_modulus value=”10” />
    <pan_checksum type=”sha256” length=”4” value=”5478” />
  </matches>
  <slot start=”1” end=”8” type=”not_merchant_readable” />
  <slot start=”9” end=”10”>
    <type value=”consumer_offer_preference” />
    <decode type=”enumerated”>
      <contains value=”1” decode=”offer_opt_in” />
      <contains value=”2” decode=”no_offers” />
      <contains value=”3”>
        <decode>occasional_offers</decode>
        <also_read slot=”10”>
          <contains value=”7” decode=”1_per_month” />
          <contains value=”8” decode=”1_per_week” />
          <contains value=”9” decode=”unlimited” />
        </also_read>
    </decode>
  </slot>
  <slot start=“10” end=”11”>
    <type value=”hybrid” />
    <decode type=”server_query” />
      <contains value=”0-6”>
      <query url=”https://paynet.com/q/$val” />
    </decode>
    <decode type=”dependent”>
      <contains value=”7-9” />
      <pass_value_to slot=”previous_slot” />
    </decode>
    <decode type=”function”>
      <contains values=”A-F” />
      <func>
        $val = string_search($val,“NLMNOP”);
      </func>
    </decode>
  </slot>
  <slot start=”12” end=”16” type=”pay_network_readable” />
</pan_template>
```

If a PAN template is found, e.g., 509, a merchant readable portion of the PAN may be determined using the PAN template, e.g., 510. As illustrated above, portions of the PAN template may contain logic that allows a merchant to identify portions of the PAN that are readable by them as well as the preference represented by different combination of PAN slot values.

In one embodiment, unprocessed consumer preferences may be extracted from the PAN using the PAN template, e.g., 511. The type of consumer preference may be determined 512 (e.g., offer opt-in, post address sharing, and/or the like) and valid values for the preference slot may be determined 513. If the CPV is valid, triggers may be set in an engagement database to facilitate the consumer preference fulfillment be the merchant, e.g., 515-516. The remaining unprocessed consumer preference values may then be extracted and processed, e.g., 517. When all consumer preference values have been processed, a token purchase authorization request may be sent to the pay network server for further consumer preference processing and transaction authorization, e.g., 507.

FIG. 6 shows a logic flow diagram illustrating example aspects of processing embedded consumer preferences, in some embodiments of the PTR. In one embodiment, a token purchase authorization request is received at a pay network server 601, e.g., 602. A tokenized preference PAN may be extracted from the tokenized purchase request, e.g., 603, and a user identifier may be similarly extracted, e.g., 604. A checksum operation, modulus operation (e.g., “$mod=$pan % 10;”), and/or the like may be performed on the extracted PAN, user identifier or other information in the tokenized purchase request in order to determine if the PAN contains consumer preferences, e.g., 605. In one embodiment, no check is done to determine if the PAN contains consumer preferences.

In one embodiment, if the PAN is a dynamic preference PAN containing consumer preferences, e.g., 606, a dynamic preference PAN template may be retrieved, e.g., 608. Further detail regarding dynamic preference PAN templates may be found herein and with respect to FIG. 5.

If a PAN template is found, e.g., 609, a pay network readable portion of the PAN may be determined using the PAN template, e.g., 610. As illustrated above with respect to FIG. 5, portions of the PAN template may contain logic that allows a pay network to identify portions of the PAN that are readable as well as the preference represented by different combination of PAN slot values.

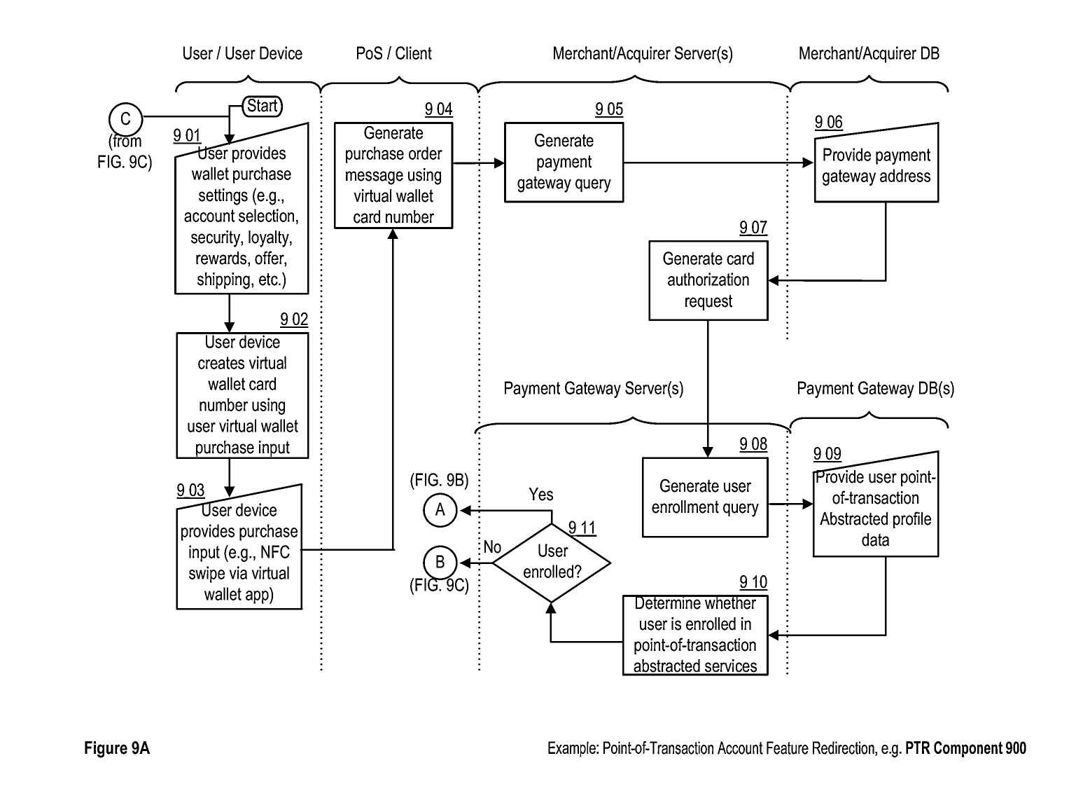

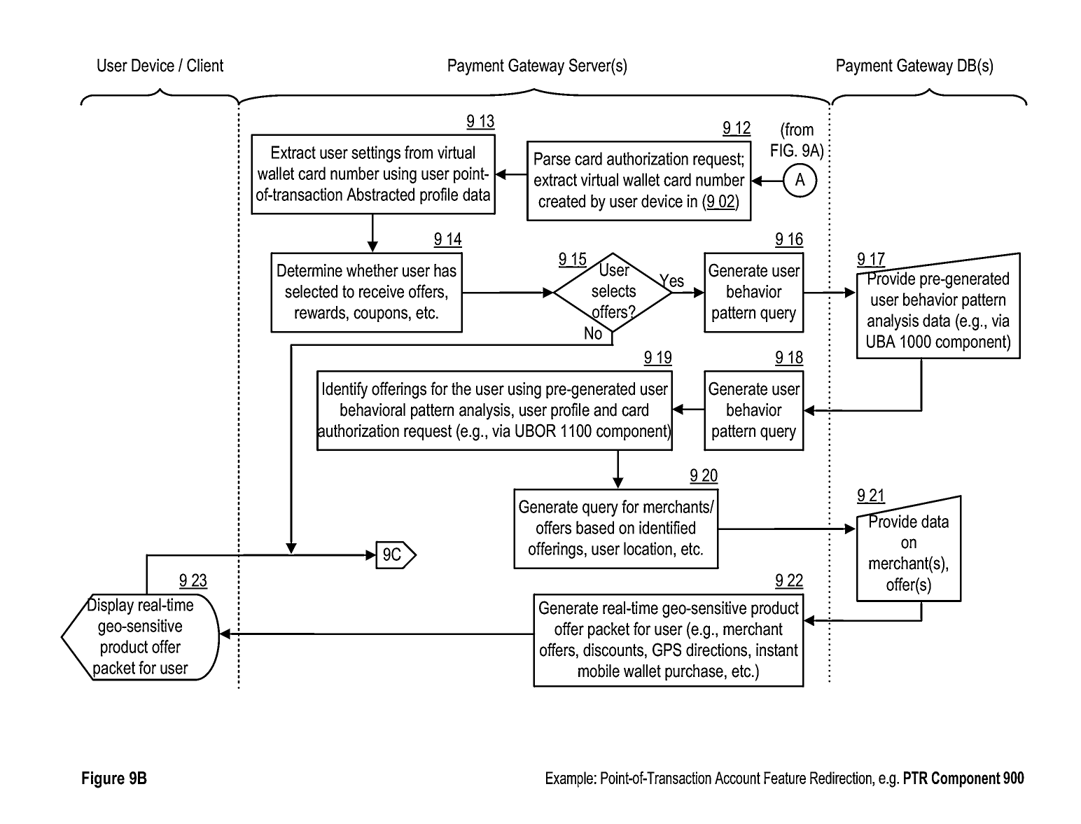

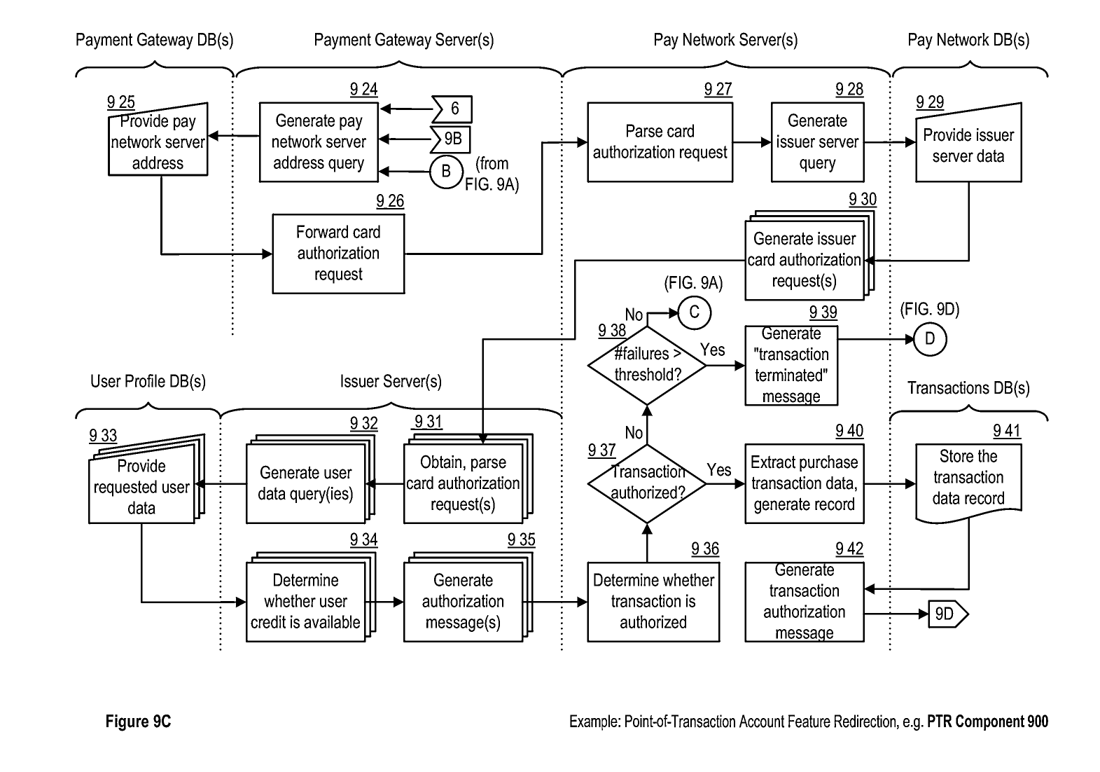

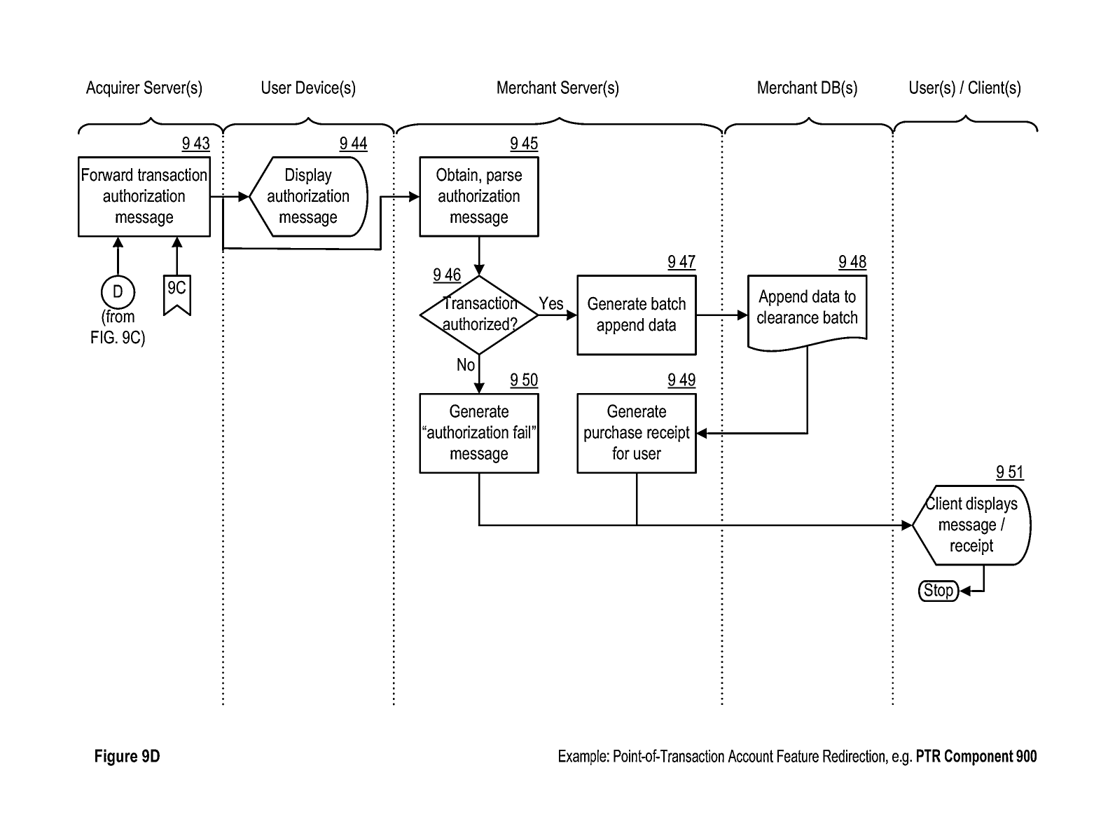

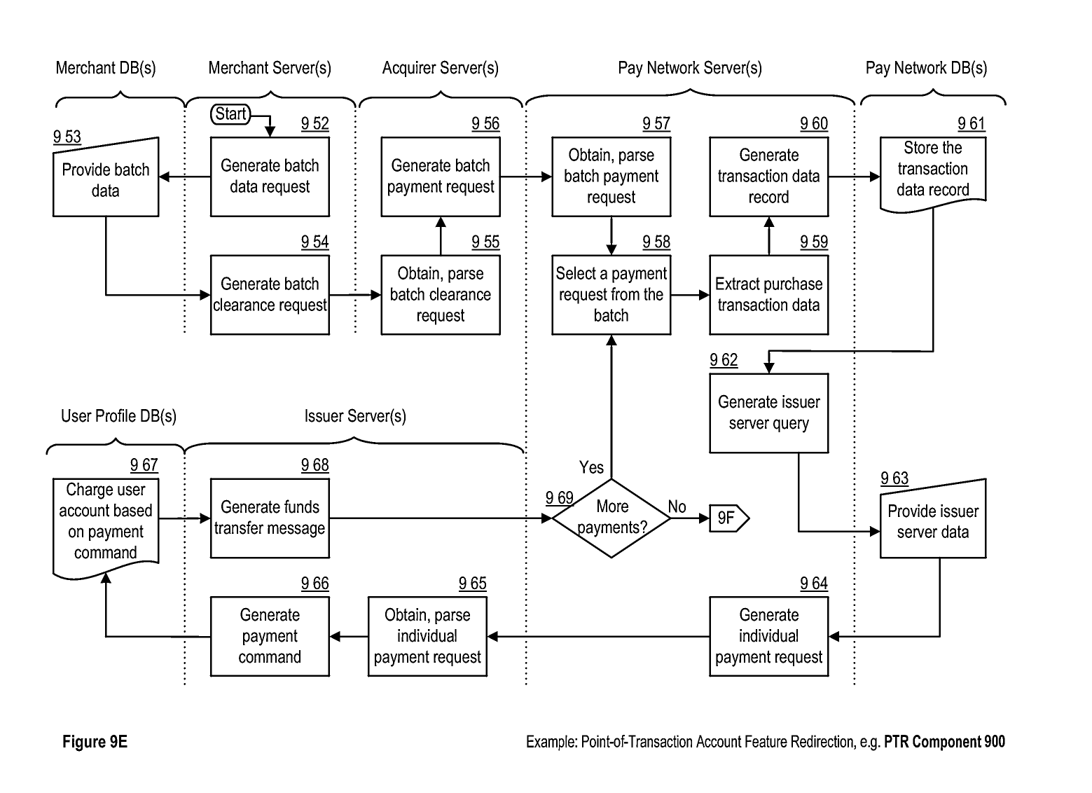

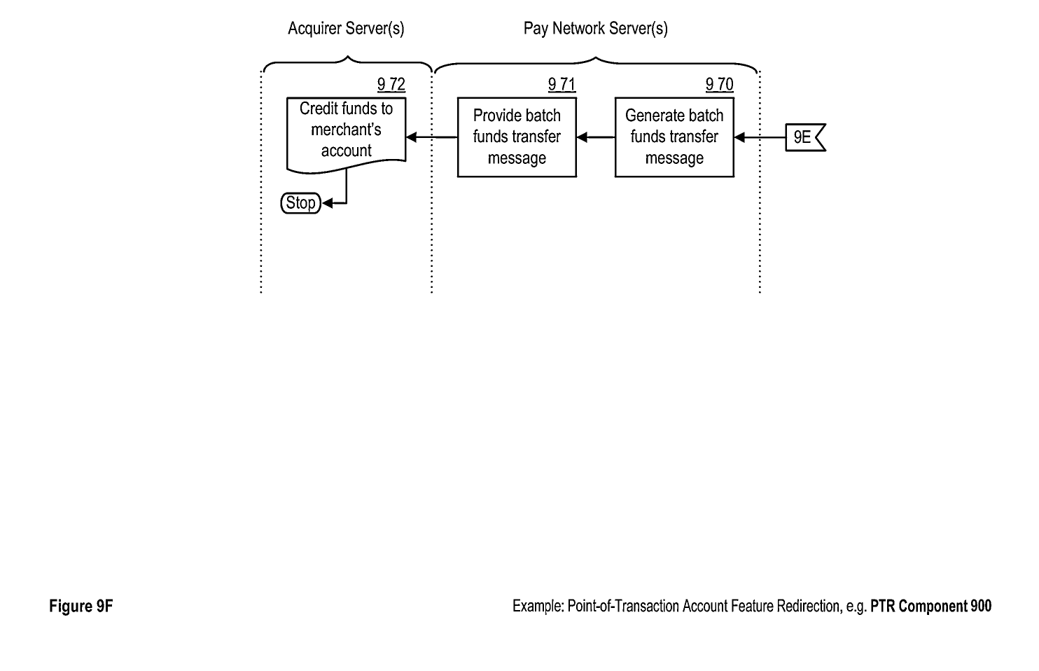

In one embodiment, unprocessed consumer preferences may be extracted from the PAN using the PAN template, e.g., 611. The type of consumer preference may be determined 612 (e.g., offer opt-in, post address sharing, and/or the like) and valid values for the preference slot may be determined 613. If the CPV is valid, triggers may be set in an engagement database to facilitate the consumer preference fulfillment by the pay network, e.g., 615-616. The remaining unprocessed consumer preference values may then be extracted and processed, e.g., 617. When all consumer preference values have been processed, the transaction amount may be extracted, e.g., 607. Transaction authorization processing continues with respect to FIG. 9C.

FIGS. 7A-C show logic flow diagrams illustrating example aspects of post transaction engagement trigger processing, in some embodiments of the PTR. In one embodiment, a post-purchase engagement procedure is launched by merchant server 701, e.g., 703. The engagement procedure may be administered by the merchant server, the pay network server 702, a third-party server, or any combination therein. If there are any unprocessed engagement triggers that are processable by the merchant, e.g., 704, the first unprocessed trigger may be extracted, e.g., 705. A trigger may be any indication that results from a consumer's preference indication. For example, if a consumer indicates that they wish to receive an offer, a merchant or pay network server may set a post-purchase engagement trigger to send offers to the consumer on a monthly schedule. In another embodiment, if a consumer preference indicates the consumer wishes to receive recall notices about a product they purchased, a trigger may periodically check for any recall notices and alert the consumer to same. Similarly, consumer preference triggers may interact, such as the trigger for sending recall notices to a consumer optionally launching triggers to collect a consumer's postal address at the next point of contact with the consumer. The action specified by the trigger may be executed by the merchant server, e.g., 706. If the trigger requires follow-up or dependent triggers 707 (i.e., sending a monthly newsletter setting a trigger to send a newsletter the following month, and/or the like), those may be set by the merchant server, e.g., 708.

In one embodiment, pay network server 702 may be queried for available post-purchase engagement actions 709. The pay network server may lookup available actions 710 and determine if any consumers have opted into the action for the merchant 711 (e.g., by indicating a dynamic tokenized PAN preference to receive offers, and/or the like). If the merchant has been specified by consumers for a given action type, e.g., 712, the engagement action may be added to a list of available actions 713. If there are no more unprocessed actions, e.g., 714, the pay network server may return a list of available engagement actions to the merchant, e.g., 715.

In one embodiment, the merchant server may extract a first unprocessed engagement action 716. If no additional pay network server data is required to fulfill the action (i.e., the merchant already has a consumer's email address for an email action, and/or the like), the merchant server may initiate the action 718 and check for more unprocessed engagement actions.

In one embodiment, the merchant server 701 may determine that pay network data is available for processing the action, e.g., 720, and query the pay network server to provide the additional data, e.g., 721. The pay network server may return the information 722 (e.g., a consumer's postal mailing address to facilitate a merchant fulfilling a consumer preference related to default shipping preferences, and/or the like) and the merchant server may initiate the action, e.g., 723. In other embodiments, if the data required for the action is not available for sharing with the merchant (i.e., the consumer indicated a preference to receive email, but not to share their address [See FIG. 12A-B and related descriptions], and/or the like), the merchant may request that the pay network server execute the required action, e.g., 724 and the pay network server may initiate the action, e.g., 725.

In one embodiment, a post-purchase engagement trigger procedure may be launched on a pay network server 702, e.g., 726. The pay network server may determine if consumers have specified the merchant for the first unprocessed engagement action, e.g., 727. Engagement actions may require additional consumer data (e.g., email address, mailing address, transaction history, and/or the like), and a consumer database may be queried by the pay network server for this purpose, e.g., 728. In one embodiment, an engagement action template corresponding to the current engagement action may be retrieved, e.g., 729. If no engagement action template is found, e.g., 730, a default engagement action template may be used, e.g., 731.

In one embodiment, merchant server data may be required by the action template 732 (i.e., current merchant purchase history, inventory levels, and/or the like). in one embodiment, the pay network server may query the merchant server for required consumer data, profile data, merchant data, and/or the like, e.g., 733. In one embodiment, the merchant server 701 may authenticate the pay network request, retrieve the required values, and respond to the request, e.g., 734. In one embodiment, the merchant values may be used to populate an action template, e.g., 735. The pay network server may then execute the action 736 (e.g., send an email, initiate a phone call, send a direct mail piece, and/or the like). If merchant consumer engagement notification preferences are set, e.g., 737, a merchant engagement notification message may be composed 738. A merchant engagement notification message 738 may contain information sufficient to appraise the merchant of actions that the pay network has taken on the merchant's behalf. For example, if the pay network server sent a follow-up email on behalf of the merchant based on a consumer preference choices, the notification may contain the email body. In some embodiments, data that is not shareable with the merchant may be removed from the notification before transmittal (e.g., removing a consumer's email address or replacing same with a pointer if the consumer indicated a preference to keep their email private, removing a consumer's name, and/or the like). In one embodiment, merchant server 701 may process the consumer engagement notification, e.g., 739, such as by logging the engagement, setting further engagement triggers for processing by the merchant or the pay network, and/or the like. In one embodiment, if follow-up engagement trigger preferences are set, e.g., 140, the pay network server 702 may set further engagement triggers itself, e.g., 741, without the intervention of the merchant. In one embodiment, the pay network server may determine that merchant triggers are required 742 (i.e., an engagement trigger for a phone call from a merchant representative after a pay network processed marketing email is sent, a trigger to mail a brochure to a consumer who has opted in for postal mail, and/or the like). In one embodiment, the merchant server may then set follow-up engagement triggers, e.g., 743.

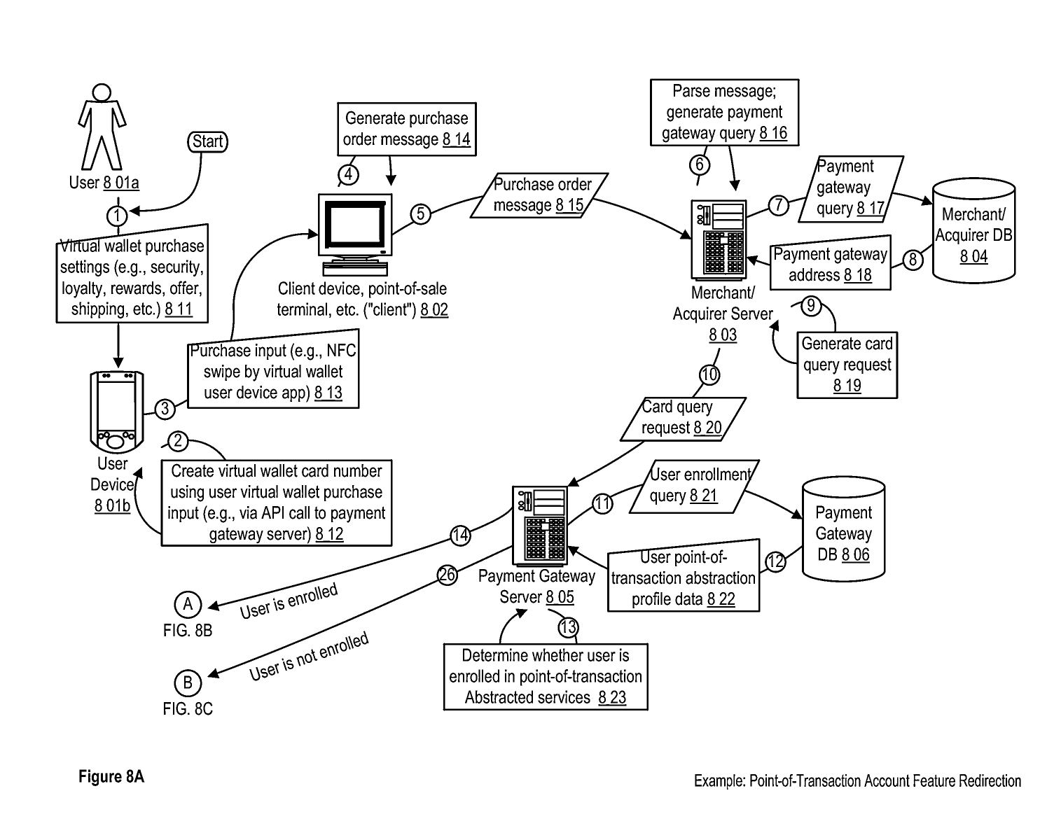

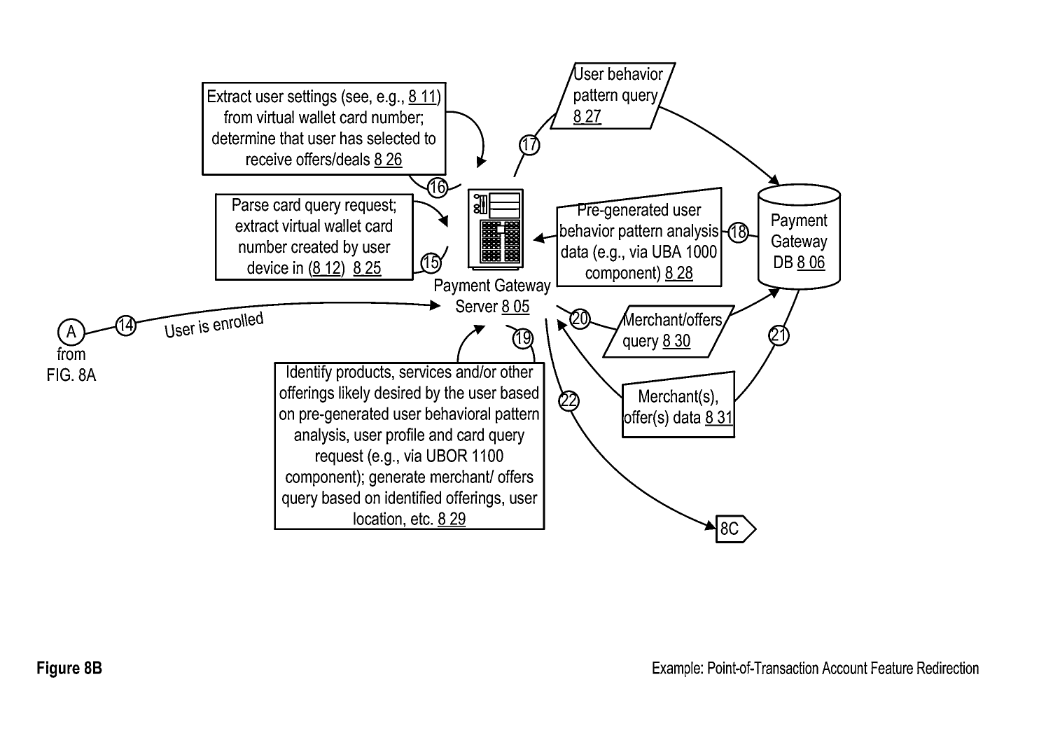

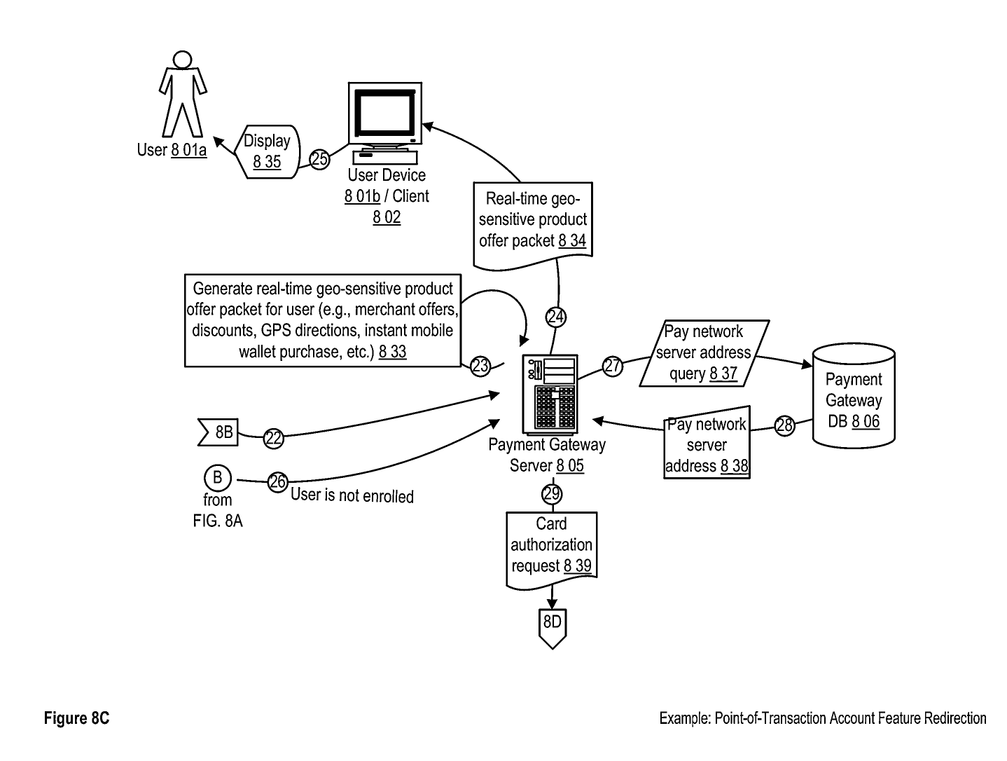

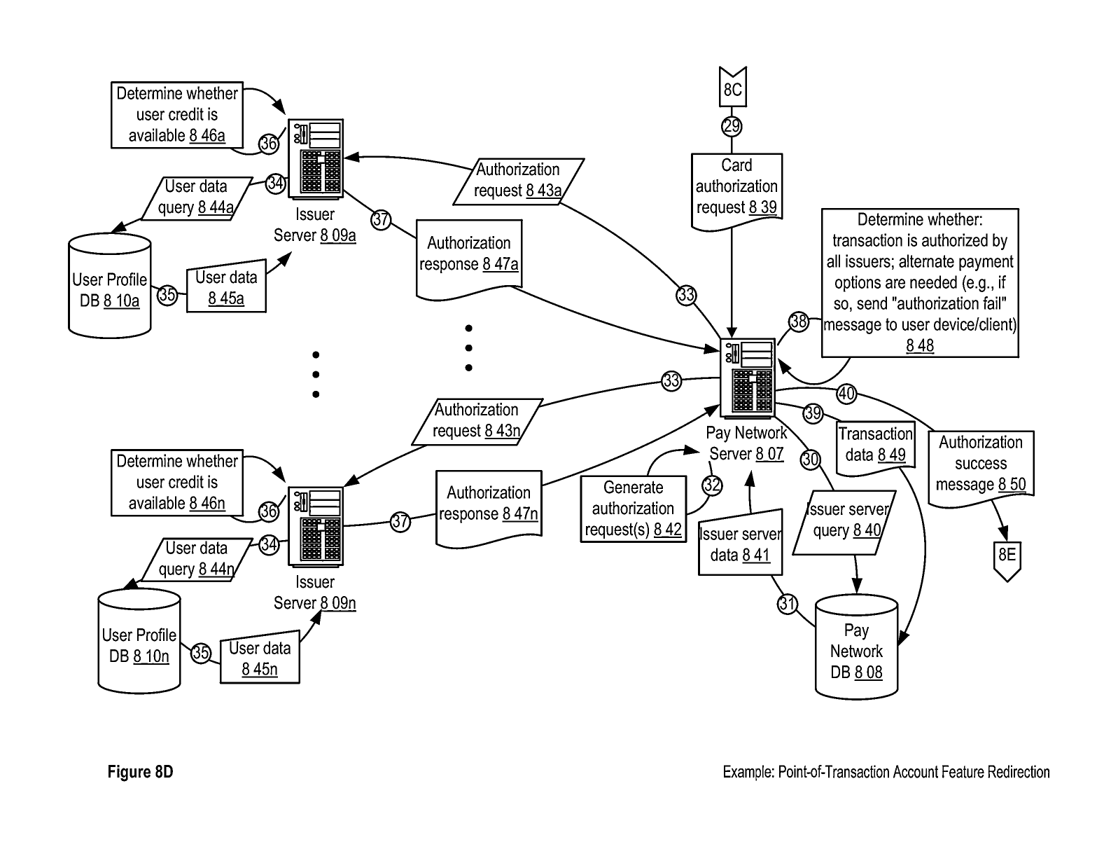

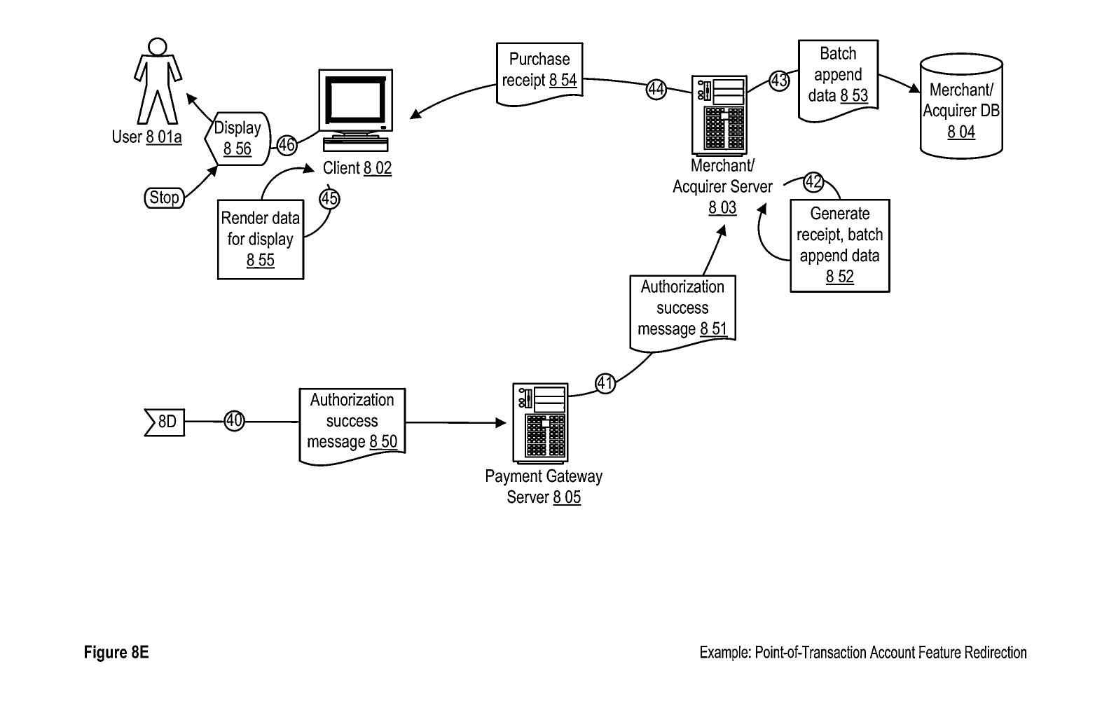

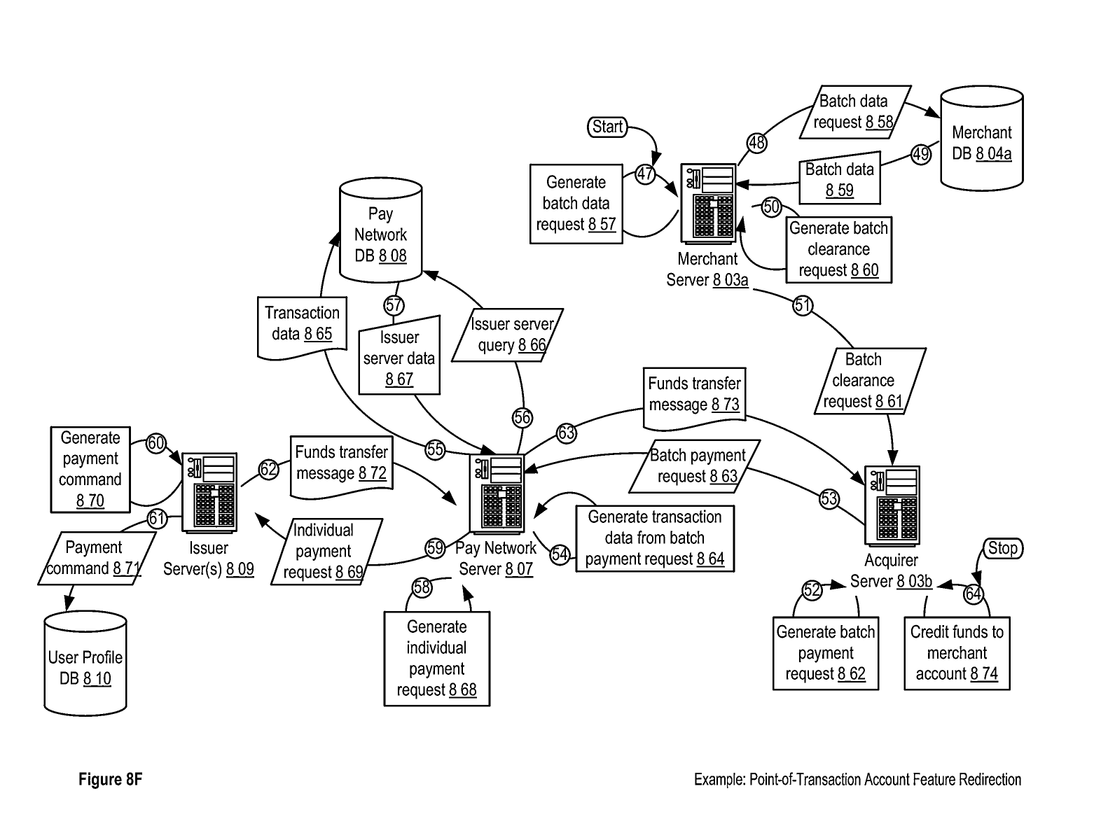

FIGS. 8A-F show data flow diagrams illustrating an example procedure for point-of-transaction account feature redirection in some embodiments of the PTR. With reference to FIG. 8A, in some implementations, a user, e.g., 801a, may desire to purchase a product, service, offering, and/or the like (“product”), from a merchant. The user may communicate with a merchant server, e.g., 803, via a client such as, but not limited to: a personal computer, mobile device, television, point-of-sale terminal, kiosk, ATM, and/or the like (e.g., 802). In some implementations, the user may utilize a user device, e.g., 801b to communicate with the client. For example, the user may provide virtual wallet purchase settings, e.g., 811, such as, but not limited to: virtual wallet account selection, wallet security settings, transaction privacy/anonymization preferences, shipping preferences, allocation of rewards points stemming from the transaction to rewards account (and/or usage of existing rewards points of the user for payment of the purchase transaction), real-time offers/notifications, posting of information on the user transaction to social media, purchase receipt delivery options, and/or the like. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like.

Upon obtaining the user's virtual wallet purchase settings, the user device may generate a virtual wallet card number using the user-selected options, 812. For example, the user device may have stored in local memory a lookup table including mapping information. The user device may utilize the mapping information in the lookup table to set the values of the flags encoded into the real-time generated virtual wallet card number according to the user's preferences. For example, the user device may generate virtual wallet card number data encoding the user's preferences similar to track 1 data from a traditional card (e.g., credit card, debit card, prepaid card, charge card, etc.), such as the example track 1 data provided below:

%B123456789012345\hat{ }PUBLIC/
J.Q.\hat{ }99011200000000000000**901******?*
(wherein ‘123456789012345’ is the card number of ‘J.Q. Public’
and has a CVV number of 901. ‘990112’ is a service code, and ***
represents decimal digits which change randomly each time the
card is used.)

In some implementations, the user device may provide an application programming interface (API) call to a payment gateway server, e.g., 805, to generate the virtual wallet card number. For example, the user device may provide a HTTP(S) POST message including the user's preferences (or flags/identifiers indicating the user's preferences) to the payment gateway server. The payment gateway server may generate a virtual wallet card number for the user, and provide the generated virtual wallet card number for the user device (e.g., via a HTTP(S) POST message). For example, the payment gateway server may access a payment gateway database, e.g., 806, for pre-configured virtual wallet card numbers, and may select one of the pre-configured numbers for transmission to the user device.

In some implementations, the user's preferences may be encoded into other data besides the virtual wallet card number. As an example, the account number may be maintained the same, regardless of the user's preferences (or lack of selection thereof), and the routing number for the transaction may be modified (e.g., for an ACH transaction). In other embodiments, the virtual wallet card number may be modified, but the routing number may be maintained the same. In still other embodiments, both routing number and virtual wallet card number may be modified to account for the user preferences. In some embodiments, the card verification value number (e.g., CVV2) may be modified to incorporate indications of the user's preferences. In general, it is to be understood that the user's preferences may be embodied via modifications to any combinations of the data/numbers that may be transmitted in a transaction exchange between any of the entities within and/or associated with the PTR. Further, it is to be understood that such modifications may be generated by any of the entities within and/or associated with the PTR, depending on the particular configuration of the PTR embodiment, and provided to others (e.g., via API calls, or during purchase transaction authorization flows).

In some implementations, the user may utilize the user device to transmit a real-time generated virtual wallet card number as purchase input to the client, e.g., 813. For example, the user device may utilize communication protocols such as, but not limited to: near-field communication, RF signals, Bluetooth™, infrared, Wi-Fi, cellular communication, telephone/modem dialing, and/or the like. Upon obtaining the purchase input, the client may generate a purchase order message, e.g., 814, and provide, e.g., 815, the generated purchase order message to the merchant server. For example, a browser application executing on the client may provide, on behalf of the user, a (Secure) Hypertext Transfer Protocol (“HTTP(S)”) POST message including the product order details for the merchant or acquirer server in the form of data formatted according to the eXtensible Markup Language (“XML”). Below is an example HTTP(S) POST message including an XML-formatted purchase order message for the merchant/acquirer server:

POST /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for

dummies</product_title>

<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>
<confirm_type>email</confirm_type>

<contact_info>john.q.public@gmail.com</contact_info>
</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant/acquirer server (“merchant server”) may obtain the purchase order message from the client, and may parse the purchase order message to extract details of the purchase order from the user. The merchant server may generate a card query request, e.g., 819, to determine whether the transaction can be processed. For example, the merchant server may attempt to determine whether the user has sufficient funds to pay for the purchase in a card account provided with the purchase order. The merchant server may also generate, e.g., 816, a payment gateway query to determine an address of a payment gateway server that can route the transaction to an appropriate payment network for transaction processing. The merchant server may provide the query, e.g., 817, to a merchant/acquirer database, e.g., 804. In response, the database may provide a URL, IP address, and/or the like address of a payment gateway server, e.g., 805, to forward the card query request.

In some implementations, the merchant server may provide the generated card query request, e.g., 820, to the payment gateway server, e.g., 805. For example, the payment gateway server may be an independent server providing point-of-transaction account feature redirection services for the user. As another example, the processes performed by the payment gateway server may be implemented as an application layer—a gateway abstraction layer—in a pay network server of a payment network. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

POST /cardquery.php HTTP/1.1
Host: www.acquirer.com
Content-Type: Application/XML
Content-Length: 624
<?XML version = “1.0” encoding = “UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for

dummies</product_summary>

<product_quantity>1</product_quantity?

</product>

</purchase_summary>
<transaction_cost>$34.78</transaction_cost>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>

</account_params>
<merchant_params>

<merchant_id>3FBCR4INC</merchant_id>
<merchant_name>Books & Things,
Inc.</merchant_name>

<merchant_auth_key>1NNF484MCP59CHB27365</
merchant_auth_key>
</merchant_params>

</card_query_request>

In some implementations, the payment gateway server may extract the details of the user from the card query request provided by the merchant server, and determine whether the user is enrolled in point-of-transaction account feature redirection services. For example, the payment gateway server may provide a user enrollment query, e.g., 821, to a payment gateway database, e.g., 806, to obtain a user point-of-transaction abstraction profile. For example, the payment gateway server may utilize a hypertext preprocessor (“PHP”) script including structured query language (“SQL”) commands to query a relational database, similar to the example below:

<?PHP
header(‘Content-Type: text/plain’);
mysql_connect(“254.93.179.112”,$DBserver,$password); // access
database server
mysql_select_db(“USERS.SQL”); // select database table to search
//create query for issuer server data
$query = “SELECT enroll_flag enroll_date enroll_expiry
enroll_class services_list mapping_matrix FROM
RedirectionServicesTable WHERE userid LIKE ‘%’ $user_id”;
$result = mysql_query($query); // perform the search query
mysql_close(“USERS.SQL”); // close database access
?>

In response, the payment gateway database may provide, e.g., 822, user point-of-transaction profile data corresponding to the user. Using the profile data, the payment gateway server may determine whether the user is enrolled in point-of-transaction account feature redirection services. For example, the payment gateway server may utilize the ‘enroll_flag’ ‘enroll_date’ and ‘enroll_expiry’ fields from the example above to determine whether the user is currently enrolled in point-of-transaction account feature redirection services. If the user is not enrolled in point-of-transaction account feature redirection services, see e.g., 839, the payment gateway server may, in some implementations, directly proceed to direct the card query request to the appropriate payment network for purchase transaction processing.

With reference to FIG. 8B, in some implementations, if the user is enrolled in point-of-transaction account feature redirection services, the payment gateway server may parse the card query request from the merchant server, and extract the virtual wallet card number generated by the user device from the card query request, e.g., 825. The payment gateway server may extract user settings form the virtual wallet card number using the user point-of-transaction abstraction profile data. For example, the payment gateway server may extract the user settings that the user input into the user device to generate the virtual wallet card number, see e.g., 811. The payment gateway server may then analyze the user settings to determine whether the user has elected to receive any point-of-transaction account feature redirection services. One example of such point-of-transaction account feature redirections services may be providing offers/deals for the user (see e.g., offers/notifications flag 236), described in further detail below. It is contemplated that the payment gateway server can provide various other services by point-of-transaction account feature redirection. In some implementations, the payment gateway server may determine that the user has elected to receive offers/deals, e.g., 826. The payment gateway server may query the payment gateway database for user behavior patterns of the user for offers/deals analytics, e.g., 827. For example, the database may be a relational database responsive to Structured Query Language (“SQL”) commands. The pay network server may execute a hypertext preprocessor (“PHP”) script including SQL commands to query the database for user behavior patterns of the user. An example PHP/SQL command listing, illustrating substantive aspects of querying the database, is provided below:

<?PHP
header(‘Content-Type: text/plain’);
mysql_connect(“254.93.179.112”,$DBserver,$password); // access
database server
mysql_select_db(“USERS.SQL”); // select database table to search
//create query for issuer server data
$query = “SELECT behavior_profile_XML FROM UserBehaviorTable
WHERE userid LIKE ‘%’ $user_id”;
$result = mysql_query($query); // perform the search query
mysql_close(“USERS.SQL”); // close database access
?>

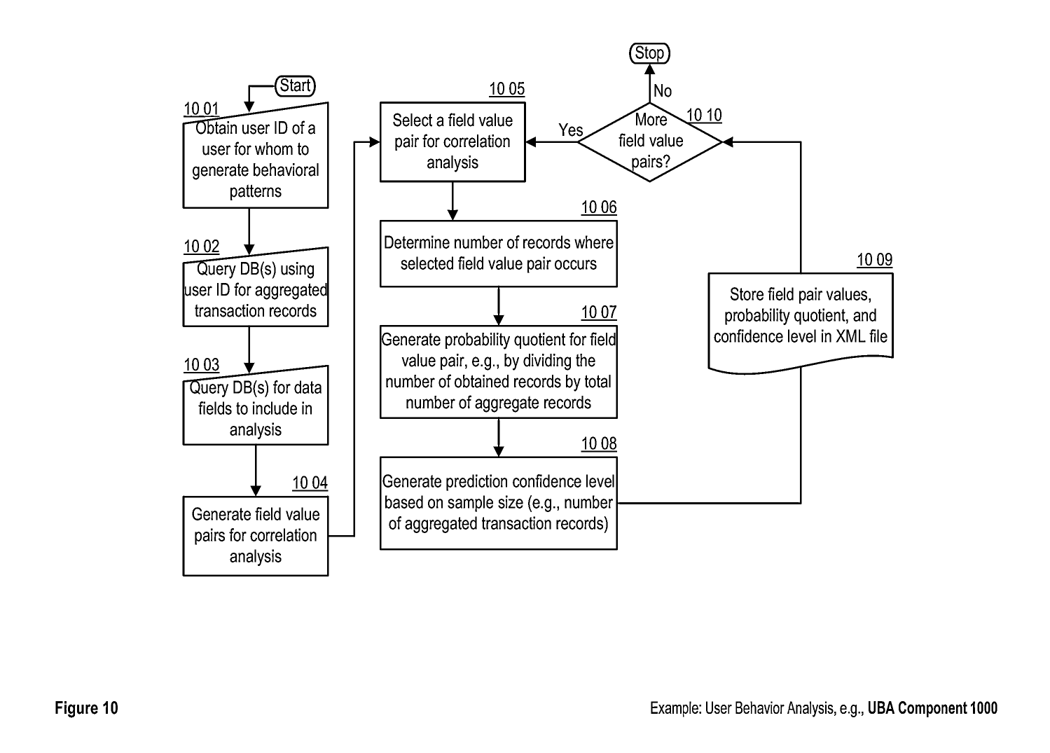

In response to obtaining the user behavior pattern query, the pay network database may provide, e.g., 828, pre-generated user behavior pattern analysis data to the payment gateway server. For example, the user behavior pattern data may comprise pair-wise correlations of various variables to each other, and/or raw user transaction patterns generated via a user behavior analysis component such as the UBA 1000 component described further below with reference to FIG. 10. An example XML-encoded user behavior pattern data file is provided below:

<?XML version = “1.0” encoding = “UTF-8”?>
<last_updated>2011-02-22 15:22:43</timestamp>
<user_ID>john.q.public@gmail.com</user_ID>
<pair_correlation_data>

<pair><time>AM</time><pdt>A</pdt><confidence>0.65</

confidence></pair>

<pair><pdt>B</pdt><pdt>A</pdt><confidence>0.95</

confidence></pair>

<pair><zip>98456</zip><pdt>A</pdt><confidence>0.25</

confidence></pair>

<pair><time>PM</time><zip>98465</zip><confidence>0.45</

confidence></pair>
</pair_correlation_data>
<raw_data>

<transaction>
<timestamp>2011-02-21 15:32:01</timestamp>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</transaction>
.
.
.
<transaction>

. . .

</transaction>

</raw_data>

In some implementations, the payment gateway server may identify

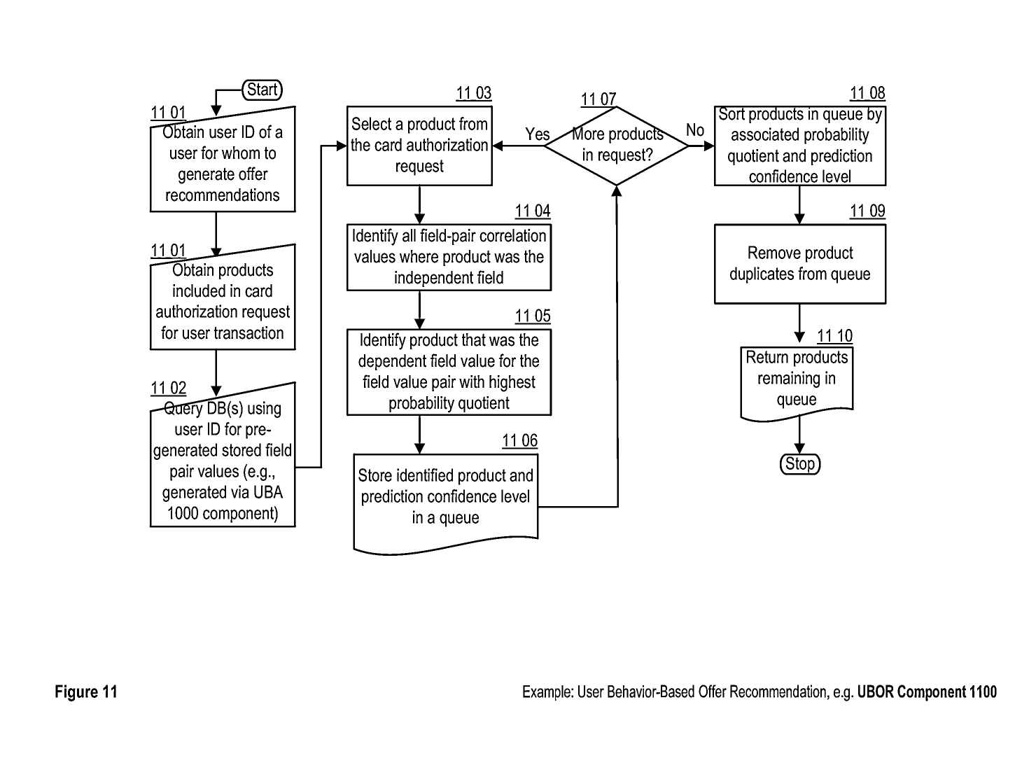

8 products, services and/or other offerings likely desired by the user based on pre-generated user behavioral pattern analysis, user profile and card query request from the merchant server, e.g., 829. For example, the payment gateway server may utilize a user-behavior based offer recommendation component such as the example UBOR 1100 component described further below with reference to FIG. 11. The payment gateway server may generate a query, e.g., 830, for merchants that may be able to provide the identified products, services, and/or offerings for the user. For example, the payment gateway server may generate a query based on the GPS coordinates of the user (e.g., obtained from the user's smartphone), the merchant store in which the user currently is present, etc., for merchants in the vicinity of the user who may have products included within the identified products likely desired by the user. In some implementations, the payment gateway server may also generate a query for offers (e.g., discount offers, Groupon® offers, etc.) that the merchant may be able to offer for the users. For example, the payment gateway server may utilize PHP/SQL commands similar to those provided above to query a database. In response, the database may provide, e.g., 831, the requested merchant and/or offer data to the payment gateway server.

With reference to FIG. 8C, in some implementations, the payment gateway server may generate a real-time merchant analytics report for the merchant, e.g., 833. In some implementations, the payment gateway server may generate a real-time geo-sensitive product offer packet for the user, e.g., including such items as (but not limited to): merchant names, location, directions, offers, discounts, interactive online purchase options, instant mobile wallet purchase ability, order hold placing features (e.g., to hold the items for pick up so as to prevent the items going out of stock, e.g., during seasonal shopping times), and/or the like. In some implementations, the payment gateway server may provide the real-time geo-sensitive product offer packet, e.g., 834, to the user device and/or client. In some implementations, the user device and/or client may render and display, e.g., 835, the real-time geo-sensitive product offer packet from the payment gateway server for the user. In some implementations, the payment gateway server may determine a payment network to which the merchant's card query request should be directed for purchase transaction processing. For example, the payment gateway server may query, e.g., 837, the payment gateway database for a network address of a pay network server to forward the card query request from the merchant server.

With reference to FIG. 8D, in some implementations, the payment gateway server may generate a card authorization request, e.g., 839, using the obtained card query request, and provide the card authorization request to a pay network server, e.g., 807. For example, the payment gateway server may redirect the HTTP(S) POST card query request from the merchant server in the example above to the pay network server. In some implementations, the pay network server may generate a query, e.g., 840, for issuer server(s) corresponding to the payment information extracted from the card authorization request. For example, the user's payment information may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 1109a-n, of the issuer(s) may maintain details of the user's account. In some implementations, a database, e.g., pay network database 808, may store details of the issuer server(s) associated with the issuer(s). For example, the database may be a relational database responsive to Structured Query Language (“SQL”) commands. The pay network server may query the pay network database for issuer server(s) details. For example, the pay network server may execute a hypertext preprocessor (“PHP”) script including SQL commands to query the database for details of the issuer server(s). An example PHP/SQL command listing, illustrating substantive aspects of querying the database, is provided below:

<?PHP
header(‘Content-Type: text/plain’);
mysql_connect(“254.93.179.112”,$DBserver,$password); // access
database server
mysql_select_db(“ISSUERS.SQL”); // select database table to
search
//create query for issuer server data
$query = “SELECT issuer_name issuer_address issuer_id ip_address
mac_address auth_key port_num security_settings_list FROM
IssuerTable WHERE account_num LIKE ‘%’ $accountnum”;
$result = mysql_query($query); // perform the search query
mysql_close(“ISSUERS.SQL”); // close database access
?>

In response to obtaining the issuer server query, e.g., 840, the pay network database may provide, e.g., 841, the requested issuer server data to the pay network server. In some implementations, the pay network server may utilize the issuer server data to generate authorization request(s), e.g., 842, for each of the issuer server(s), and provide the card authorization request(s), e.g., 843a-n, to the issuer server(s), e.g., 809a-n. In some implementations, the authorization request(s) may include details such as, but not limited to: the costs to the user involved in the transaction, card account details of the user, user billing and/or shipping information, and/or the like. For example, the pay network server may provide a HTTP(S) POST message including an XML-formatted authorization request similar to the example listing provided below:

POST /authorization.php HTTP/1.1
Host: www.issuer.com
Content-Type: Application/XML
Content-Length: 624
<?XML version = “1.0” encoding = “UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for

dummies</product_summary>

<product_quantity>1</product_quantity?

</product>

</purchase_summary>
<transaction_cost>$22.61</transaction_cost>
<account_params>

<account_type>token</account_type>
<account_num>1234567890123456</account_num>

</account_params>
<merchant_params>

<merchant_id>3FBCR4INC</merchant_id>
<merchant_name>Books & Things,
Inc.</merchant_name>

<merchant_auth_key>1NNF484MCP59CHB27365</
merchant_auth_key>
</merchant_params>

</card_query_request>

In some implementations, an issuer server may parse the authorization request(s), and based on the request details may query, e.g., 844a-n, a database, e.g., user profile database 1110a-n, for data associated with the user's account. For example, the issuer server may issue PHP/SQL commands similar to the example provided below:

<?PHP
header(‘Content-Type: text/plain’);
mysql_connect(“254.93.179.112”,$DBserver,$password); // access
database server
mysql_select_db(“USERS.SQL”); // select database table to search
//create query for user data
$query = “SELECT user_id user_name user_balance account_type
FROM UserTable WHERE account_num LIKE ‘%’ $accountnum”;
$result = mysql_query($query); // perform the search query
mysql_close(“USERS.SQL”); // close database access
?>

In some implementations, on obtaining the user data, e.g., 845a-n, the issuer server may determine whether the user can pay for the transaction using funds available in the account, e.g., 846a-n. For example, the issuer server may determine whether the user has a sufficient balance remaining in the account, sufficient credit associated with the account, and/or the like. Based on the determination, the issuer server(s) may provide an authorization response, e.g., 847a-n, to the pay network server. For example, the issuer server(s) may provide a HTTP(S) POST message similar to the examples above. In some implementations, if at least one issuer server determines that the user cannot pay for the transaction using the funds available in the account, see e.g., 848, the pay network server may request payment options again from the user (e.g., by providing an authorization fail message to the user device and/or client and requesting new payment options input again from the user), and re-attempt authorization for the purchase transaction. In some implementations, if the number of failed authorization attempts exceeds a threshold, the pay network server may abort the authorization process, and provide an “authorization fail” message to the merchant server, user device and/or client.

In some implementations, the pay network server may obtain the authorization message including a notification of successful authorization, and parse the message to extract authorization details. Upon determining that the user possesses sufficient funds for the transaction, the pay network server may generate a transaction data record, e.g., 849, from the authorization request and/or authorization response, and store the details of the transaction and authorization relating to the transaction in a transactions database. For example, the pay network server may issue PHP/SQL commands similar to the example listing below to store the transaction data in a database:

<?PHP
header(‘Content-Type: text/plain’);
mysql_connect(″254.92.185.103”,$DBserver,$password); // access
database server
mysql_select(″TRANSACTIONS.SQL”); // select database to append
mysql_query(“INSERT INTO PurchasesTable (timestamp,
purchase_summary_list, num_products, product_summary,
product_quantity, transaction_cost, account_params_list,
account_name, account_type, account_num, billing_addres, zipcode,
phone, sign, merchant_params_list, merchant_id, merchant_name,
merchant_auth_key)
VALUES (time( ), $purchase_summary_list, $num_products,
$product_summary, $product_quantity, $transaction_cost,
$account_params_list, $account_name, $account_type, $account_num,
$billing_addres, $zipcode, $phone, $sign, $merchant_params_list,
$merchant_id, $merchant_name, $merchant_auth_key)”); // add data
to table in database
mysql_close(“TRANSACTIONS.SQL”); // close connection to database
?>

With reference to FIG. 8E, in some implementations, the pay network server may forward an authorization success message, e.g., 850, to the payment gateway server, which may in turn forward the authorization success message, e.g., 851, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 852, and store the XML data file, e.g., 853, in a database, e.g., 804. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</
merchant_auth_key>
<account_number>123456789</account_number>

</merchant_data>
<transaction_data>

<transaction 1>

...

</transaction 1>
<transaction 2>

...

</transaction2>

.
.
.

<transaction n>

...

</transaction n>

</transaction_data>

In some implementations, the server may also generate a purchase receipt, e.g., 852, and provide the purchase receipt to the client, e.g., 854. The client may render and display, e.g., 855-856, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 8F, in some implementations, the merchant server may initiate clearance of a batch of authorized transactions. For example, the merchant server may generate a batch data request, e.g., 857, and provide the request, e.g., 858, to a database, e.g., merchant database 804a. For example, the merchant server may utilize PHP/SQL commands similar to the examples provided above to query a relational database. In response to the batch data request, the database may provide the requested batch data, e.g., 859. The server may generate a batch clearance request, e.g., 860, using the batch data obtained from the database, and provide, e.g., 861, the batch clearance request to an acquirer server, e.g., 803b. For example, the merchant server may provide a HTTP(S) POST message including XML-formatted batch data in the message body for the acquirer server. The acquirer server may generate, e.g., 862, a batch payment request using the obtained batch clearance request, and provide the batch payment request to the pay network server, e.g., 863. The pay network server may parse the batch payment request, and extract the transaction data for each transaction stored in the batch payment request, e.g., 864. The pay network server may store the transaction data, e.g., 865, for each transaction in a database, e.g., pay network database 808. For each extracted transaction, the pay network server may query, e.g., 866-867, a database, e.g., pay network database 808, for an address of an issuer server. For example, the pay network server may utilize PHP/SQL commands similar to the examples provided above. The pay network server may generate an individual payment request, e.g., 868, for each transaction for which it has extracted transaction data, and provide the individual payment request, e.g., 869, to the issuer server, e.g., 809. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK

98765</billing_address>

<phone>123-456-7809</phone>
<sign>/jqp/</sign>

</account_params>
<merchant_params>

<merchant_id>3FBCR4INC</merchant_id>
<merchant_name>Books & Things, Inc.</
merchant_name>

<merchant_auth_key>1NNF484MCP59CHB27365</
merchant_auth_key>
</merchant_params>
<purchase_summary>

<num_products>1</num_products>
<product>

<product_summary>Book - XML for

dummies</product_summary>

<product_quantity>1</product_quantity?

</product>

</purchase_summary>

</pay_request>

In some implementations, the issuer server may generate a payment command, e.g., 870. For example, the issuer server may issue a command to deduct funds from the user's account (or add a charge to the user's credit card account). The issuer server may issue a payment command, e.g., 871, to a database storing the user's account information, e.g., user profile database 810. The issuer server may provide a funds transfer message, e.g., 872, to the pay network server, which may forward, e.g., 873, the funds transfer message to the acquirer server. An example HTTP(S) POST funds transfer message is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
        <request_ID>CNI4ICNW2</request_ID>
        <clear_flag>true</clear_flag>
        <timestamp>2011-02-22 17:00:02</timestamp>
        <deposit_amount>$34.78</deposit_amount>
</deposit_ack>
```

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 874.

FIGS. 9A-F show logic flow diagrams illustrating example aspects of point-of-transaction account feature redirection in some embodiments of the PTR, e.g., a Point-of-Transaction Account Feature Redirection (“PTR”) component 900. With reference to FIG. 9A, in some implementations, a user may desire to purchase a product, service, offering, and/or the like (“product”), from a merchant. The user may provide into the user's device virtual wallet purchase settings, e.g., 901, such as, but not limited to: virtual wallet account selection, wallet security settings, transaction privacy/anonymization preferences, shipping preferences, allocation of rewards points stemming from the transaction to rewards account (and/or usage of existing rewards points of the user for payment of the purchase transaction), real-time offers/notifications, posting of information on the user transaction to social media, purchase receipt delivery options, and/or the like. Upon obtaining the user's virtual wallet purchase settings, the user device may generate a virtual wallet card number using the user-selected options, e.g., 902. For example, the user device may have stored in local memory a lookup table including mapping information. The user device may utilize the mapping information in the lookup table to set the values of the flags encoded into the real-time generated virtual wallet card number according to the user's preferences. For example, the user device may generate virtual wallet card number data encoding the user's preferences.

In some implementations, the user may utilize the user device to transmit the real-time generated virtual wallet card number as purchase input to the client, e.g., 903. Upon obtaining the purchase input, the client may generate a purchase order message, e.g., 904, and provide the generated purchase order message to the merchant server. In some implementations, the merchant/acquirer server (“merchant server”) may obtain the purchase order message from the client, and may parse the purchase order message to extract details of the purchase order from the user. The merchant server may generate, e.g., 905, a payment gateway query to determine an address of a payment gateway server that can route the transaction to an appropriate payment network for transaction processing. The merchant server may provide the query to a merchant/acquirer database. In response, the database may provide a URL, IP address, and/or the like address of a payment gateway server, e.g., 906.

The merchant server may generate a card query request, e.g., 907, to determine whether the transaction can be processed. For example, the merchant server may attempt to determine whether the user has sufficient funds to pay for the purchase in a card account provided with the purchase order. In some implementations, the merchant server may provide the generated card query request to a payment gateway server based on the payment gateway address obtained from the merchant/acquirer database. In some implementations, the payment gateway server may extract the details of the user from the card query request provided by the merchant server, and determine whether the user is enrolled in point-of-transaction account feature redirection services. For example, the payment gateway server may generate a user enrollment query, e.g., 908, and provide the query to a payment gateway database to obtain a user point-of-transaction abstraction profile for the user initiating the purchase transaction.

In response, the payment gateway database may provide, e.g., 909, user point-of-transaction profile data corresponding to the user. Using the profile data, the payment gateway server may determine whether the user is enrolled in point-of-transaction account feature redirection services, e.g., 910. If the user is not enrolled in point-of-transaction account feature redirection services, e.g., 911, option “No,” the payment gateway server may, in some implementations, directly proceed to direct the card query request to the appropriate payment network for purchase transaction processing (see FIG. 9C-F).

With reference to FIG. 9B, in some implementations, if the user is enrolled in point-of-transaction account feature redirection services (see, e.g., FIG. 9A, 911, option “Yes”) the payment gateway server may parse the card query request from the merchant server, and extract the virtual wallet card number generated by the user device from the card query request, e.g., 912. The payment gateway server may extract user settings form the virtual wallet card number using the user point-of-transaction abstraction profile data, e.g., 913. For example, the payment gateway server may extract the user settings that the user input into the user device to generate the virtual wallet card number. The payment gateway server may then analyze the user settings to determine whether the user has elected to receive any point-of-transaction account feature redirection services, e.g., 914. In some implementations, the payment gateway server may determine that the user has elected to receive offers/deals, e.g., 915, option “Yes.” In such implementations, the payment gateway server may query the payment gateway database for user behavior patterns of the user for offers/deals analytics, e.g., 916. In response to obtaining the user behavior pattern query, the pay network database may provide, e.g., 917, pre-generated user behavior pattern analysis data to the payment gateway server. For example, the user behavior pattern data may comprise pair-wise correlations of various variables to each other, and/or raw user transaction patterns generated via a user behavior analysis component such as the UBA 1000 component described further below with reference to FIG. 10.

In some implementations, the payment gateway server may identify products, services and/or other offerings likely desired by the user based on pre-generated user behavioral pattern analysis, user profile and card query request from the merchant server, e.g., 919. For example, the payment gateway server may utilize a user-behavior based offer recommendation component such as the example UBOR 1100 component described further below with reference to FIG. 11. The payment gateway server may generate a query, e.g., 920, for merchants that may be able to provide the identified products, services, and/or offerings for the user. For example, the payment gateway server may generate a query based on the GPS coordinates of the user (e.g., obtained from the user's smartphone), the merchant store in which the user currently is present, etc., for merchants in the vicinity of the user who may have products included within the identified products likely desired by the user. In some implementations, the payment gateway server may also generate a query for offers (e.g., discount offers, Groupon® offers, etc.) that the merchant may be able to offer for the users. In response, the database may provide, e.g., 921, the requested merchant and/or offer data to the payment gateway server. In some implementations, the payment gateway server may generate a real-time geo-sensitive product offer packet for the user, e.g. 922, including such items as (but not limited to): merchant names, location, directions, offers, discounts, interactive online purchase options, instant mobile wallet purchase ability, order hold placing features (e.g., to hold the items for pick up so as to prevent the items going out of stock, e.g., during seasonal shopping times), and/or the like. In some implementations, the payment gateway server may provide the real-time geo-sensitive product offer packet to the user device and/or client. In some implementations, the user device and/or client may render and display, e.g., 923, the real-time geo-sensitive product offer packet from the payment gateway server for the user.

With reference to FIG. 9C, in some implementations, the payment gateway server may determine a payment network to which the merchant's card query request should be directed for purchase transaction processing. For example, the payment gateway server may query, e.g., 924-925, the payment gateway database for a network address of a pay network server to forward a card query request from the merchant server. The payment gateway server may generate a card authorization request, e.g., 926, using the obtained card query request, and provide the card authorization request to a pay network server. In some implementations, the pay network server may parse the received card authorization request, e.g., 927, and generate a query, e.g., 928, for issuer server(s) corresponding to the payment information extracted from the card authorization request. For example, the user's payment information may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account. In some implementations, a pay network database may store details of the issuer server(s) associated with the issuer(s). The pay network server may query the pay network database for issuer server(s) details.

In response to obtaining the issuer server query, e.g., 928, the pay network database may provide, e.g., 929, the requested issuer server data to the pay network server. In some implementations, the pay network server may utilize the issuer server data to generate authorization request(s), e.g., 930, for each of the issuer server(s), and provide the card authorization request(s) to the issuer server(s). In some implementations, the authorization request(s) may include details such as, but not limited to: the costs to the user involved in the transaction, card account details of the user, user billing and/or shipping information, and/or the like. In some implementations, an issuer server may parse the authorization request(s), e.g., 931, and based on the request details may query, e.g., 932, a user profile database for data associated with an account. In some implementations, on obtaining the user data the issuer server may determine whether the user can pay for the transaction using funds available in the account, e.g., 934. For example, the issuer server may determine whether the user has a sufficient balance remaining in the account, sufficient credit associated with the account, and/or the like. Based on the determination, the issuer server(s) may provide an authorization response, e.g., 935, to the pay network server. In some implementations, if at least one issuer server determines that the user cannot pay for the transaction using the funds available in the account, see e.g., 936-937, the pay network server may request payment options again from the user (e.g., by providing an authorization fail message to the user device and/or client and requesting new payment options input again from the user), and re-attempt authorization for the purchase transaction. In some implementations, if the number of failed authorization attempts exceeds a threshold, see e.g., 938, option “Yes,” the pay network server may abort the authorization process, and provide an “authorization fail” message to the merchant server, user device and/or client, e.g., 939.

In some implementations, the pay network server may obtain the authorization message including a notification of successful authorization, e.g., 937, option “Yes,” and parse the message to extract authorization details. Upon determining that the user possesses sufficient funds for the transaction, the pay network server may generate a transaction data record, e.g., 940, from the authorization request and/or authorization response, and store, e.g., 941, the details of the transaction and authorization relating to the transaction in a transactions database.

With reference to FIG. 9D, in some implementations, the pay network server may forward an authorization success message, e.g., FIG. 9C, 942, to the payment gateway server, which may in turn forward the authorization success message, e.g., 943, to the merchant server. The merchant may parse the authorization message, e.g., 945, and determine from it that the user possesses sufficient funds in the card account to conduct the transaction, see e.g., 946. The merchant server may add a record of the transaction for the user to a batch of transaction data relating to authorized transactions, e.g., 947-948. In some implementations, the server may also generate a purchase receipt, e.g., 949, and provide the purchase receipt to the client. The client may render and display, e.g., 951, the purchase receipt for the user.

With reference to FIG. 9E, in some implementations, the merchant server may initiate clearance of a batch of authorized transactions. For example, the merchant server may generate a batch data request, e.g., 952, and provide the request to a database, e.g., a merchant database. In response to the batch data request, the database may provide the requested batch data, e.g., 953. The server may generate a batch clearance request, e.g., 954, using the batch data obtained from the database, and provide the batch clearance request to an acquirer server. The acquirer server may generate, e.g., 956, a batch payment request using the obtained batch clearance request, and provide the batch payment request to the pay network server. The pay network server may parse the batch payment request, and extract the transaction data for each transaction stored in the batch payment request, e.g., 957-959. The pay network server may store the transaction data, e.g., 960-961, for each transaction in a database, e.g., pay network database. For each extracted transaction, the pay network server may query, e.g., 962-963, a database, e.g., pay network database, for an address of an issuer server. The pay network server may generate an individual payment request, e.g., 964, for each transaction for which it has extracted transaction data, and provide the individual payment request to the associated issuer server.

In some implementations, the issuer server may generate a payment command, e.g., 965-966. For example, the issuer server may issue a command to deduct funds from the user's account (or add a charge to the user's credit card account). The issuer server may issue a payment command, e.g., 966, to a database storing the user's account information, e.g., user profile database. The issuer server may provide a funds transfer message, e.g., 968, to the pay network server, which may forward the funds transfer message to the acquirer server. In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 970-972.

FIG. 10 shows a logic flow diagram illustrating example aspects of analyzing a user's behavior based on aggregated purchase transaction data in some embodiments of the PTR, e.g., a User Behavior Analysis (“UBA”) component 1000. In some implementations, a pay network server (“server”) may obtain a user ID of a user for whom the server is required to generate user behavioral patterns, e.g., 1001. The server may query a database, e.g., a pay network database, for aggregated card transaction data records of the user, e.g., 1002. The server may also query, e.g., 1003, the pay network database for all possible field value that can be taken by each of the field values (e.g., AM/PM, zipcode, merchant_ID, merchant_name, transaction cost brackets, etc.). Using the field values of all the fields in the transaction data records, the server may generate field value pairs, for performing a correlation analysis on the field value pairs, e.g., 1004. An example field value pair is: ‘time’ is ‘AM’ and ‘merchant’ is ‘Walmart’. The server may then generate probability estimates for each field value pair occurring in the aggregated transaction data records. For example, the server may select a field value pair, e.g., 1005. The server may determine the number of records within the aggregated transaction data records where the field value pair occurs, e.g., 1006. The server may then calculate a probability quotient for the field value pair by dividing the number determined for the occurrences of the field value pair by the total number of aggregate transaction data records, e.g., 1007. The server may also assign a confidence level for the probability quotient based on the sample size, e.g., total number of records in the aggregated transaction data records, e.g., 1008. The server may generate and store an XML snippet, such as described above with reference to FIG. 8B, including the field value pair, the probability quotient, and the confidence level associated with the probability quotient, e.g., 1009. The server may perform such a computation for each field value pair (see 1010) generated in 1004.

FIG. 11 shows a logic flow diagram illustrating example aspects of generating recommendations for a user based on the user's prior aggregate purchase transaction behavior in some embodiments of the PTR, e.g., a User Behavior-Based Offer Recommendations (“UBOR”) component 1100. In some implementations, a pay network server (“server”) may obtain a user ID of a user for whom the server is required to generate offer recommendations, e.g., 1101. The server may obtain a list of products included in a card authorization request for processing the purchase transaction for the user, e.g., 1102. The server may also query a database for pre-generated pair-wise correlations of various user transaction-related variables, such as those generated by the UBA 1000 component described above with reference to FIG. 10. The server may select a product from the list of products included in the card authorization request, e.g., 1103. The server may identify all field pair-correlation values where the selected product was the independent field into the field-pair correlation, e.g., 1104. The server may, e.g., 1105, from among the identified field-pair values, identify the product that was the dependent field value for the field value pair having the highest probability quotient (e.g., product most likely to be bought together with the product selected from the product list included in the card authorization request). The server may store the identified product, along with its associated prediction confidence level, in a queue of products for recommendation, e.g., 1106. The server may perform the analysis for each product included in the product list from the card authorization request, see e.g., 1107.

In some implementations, upon completing such an analysis for all the products in the card authorization request, the server may sort the queue according to their associated probability quotient and prediction confidence level, e.g., 1108. For example, if the prediction confidence level of a product is higher than a threshold, then it may be retained in the queue, but not if the prediction confidence level is lower than the threshold. Also, the retained products may be sorted in descending order of their associated probability quotients. In some implementations, the server may eliminate any duplicated products form the queue, e.g., 1109. The server may return the sorted queue of products for product offer recommendation, e.g., 1110.

FIGS. 12A-B show user interface diagrams illustrating example aspects of account feature redirection tokenized PAN creation, in some embodiments of the PTR. In one embodiment, a user may run an application on their mobile device, e.g., 1201, allowing the specification of user preference value and the generation of dynamic PAN inputs. The PAN inputs are illustrated here in the form of a series of integers of a length commonly associated with a payment account. However, in other embodiments, the generated PAN may be in the form of a non-standard series length of integers, a combination of alphanumeric and numeric characters in any discernable character set, a signal definition suitable for transmission (e.g., a data package suitable for transmission using WiFi, NFC, and/or the like), a visual scanable representation of the output (e.g., a bar code, QR code, patterned flash of light, and/or the like), an auditory sequence (e.g., via a mobile device's speaker, headphone jack, Bluetooth Stereo interface and/or the like) and/or the like.

In one embodiment, a user may specify if they wish to share their identify with a merchant 1202. As described herein, personal information sufficient to establish the consumer's identify may be encoded into the dynamic PAN, retrievable via information contained in the dynamic PAN, and/or the like. In so doing, the PTR may enable a consumer to maintain privacy while engaging in transactions with a merchant. In one embodiment, a maximum purchase amount may be specified, e.g., 1203. In other embodiments, a consumer may encode a preference to receive offers, e.g., 1204 and/or share their postal/mailing address 1205 (which may be indicated independently by the consumer or in some embodiments used in conjunction with the shared identity preference of the PTR, e.g. 1202). In still other embodiments, a consumer may indicate that they wish to share an email contact mechanism with a merchant, e.g., 1206. In one embodiment, the consumer's address may be hidden from the merchant 1206a (e.g., by forcing the merchant to relay emails to the consumer through a third-party service, through the use of time limited email address, and/or the like). Additionally, in one embodiment, the consumer may specify a preference about the frequency, rate or total number of email contacts a merchant may make with the consumer, e.g., 1206b. In one embodiment, consumers may opt to receive warranty reminders about products they have purchased or expressed an interest in 1207, store receipts with a third party 1208 (e.g., a virtual wallet provider, a payment network, a merchant server, a personal private cloud, and/or the like), receive recall notices associated with products they have purchased 1209, post their transactions or privacy settings to their or other's social media accounts 1210 and/or enroll in or use a merchant's rewards account 1211. In one embodiment, the rewards account may be sponsored or associated with a third party. In so doing, the PTR enables a consumer to automatically receive rewards points in a centralized account without communicating third-party rewards account information to a given merchant. In one embodiment, a current dynamic PAN is displayed 1212 and the consumer may update the dynamic pan to reflect the current preferences selected 1213. In other embodiments, the dynamic PAN is not displayed to the consumer or merchant to enhance privacy and transaction security. In still other embodiments, the dynamic PAN is time-limited when the user requests to view the dynamic PAN, so that time-limited PAN inputs (e.g., PAN collision server responses, cached available PAN time slots, and/or the like) that may be cached on the user's device as described are only used when required for enhanced account security.

With respect to FIG. 12B, after generating a dynamic PAN the consumer may then, in one embodiment, select a method of transmission of the PAN to a merchant, e.g., 1214. For example, the PAN may be transmitted by NFC 1215, over a WiFi network 1216, by scanning a barcode on a POS terminal 1217 (e.g., through a mutual visual authentication, an out of-band message from the user's mobile device to the POS terminal, and/or the like), by a transmission using the mobile device's headphone jack 1218 (e.g., by a POS audio interface jack, and/or the like) or by a merchant scanable visual encoding on the consumer's mobile device 1219.

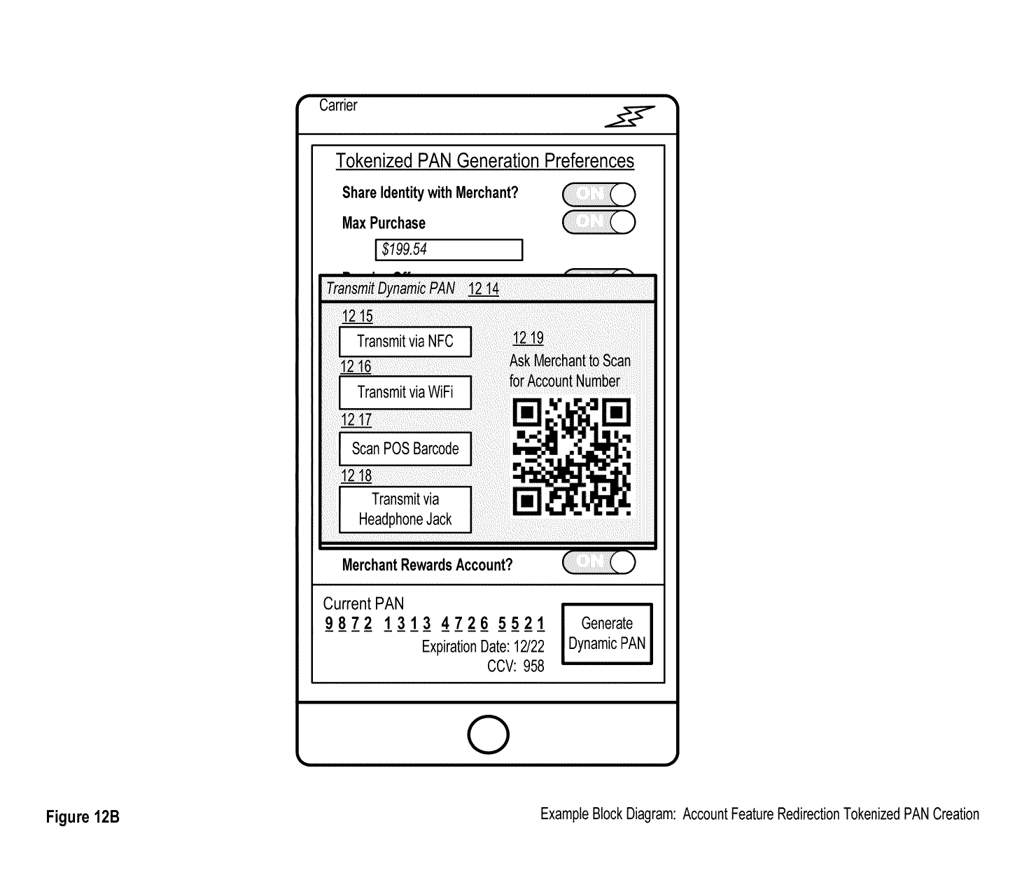

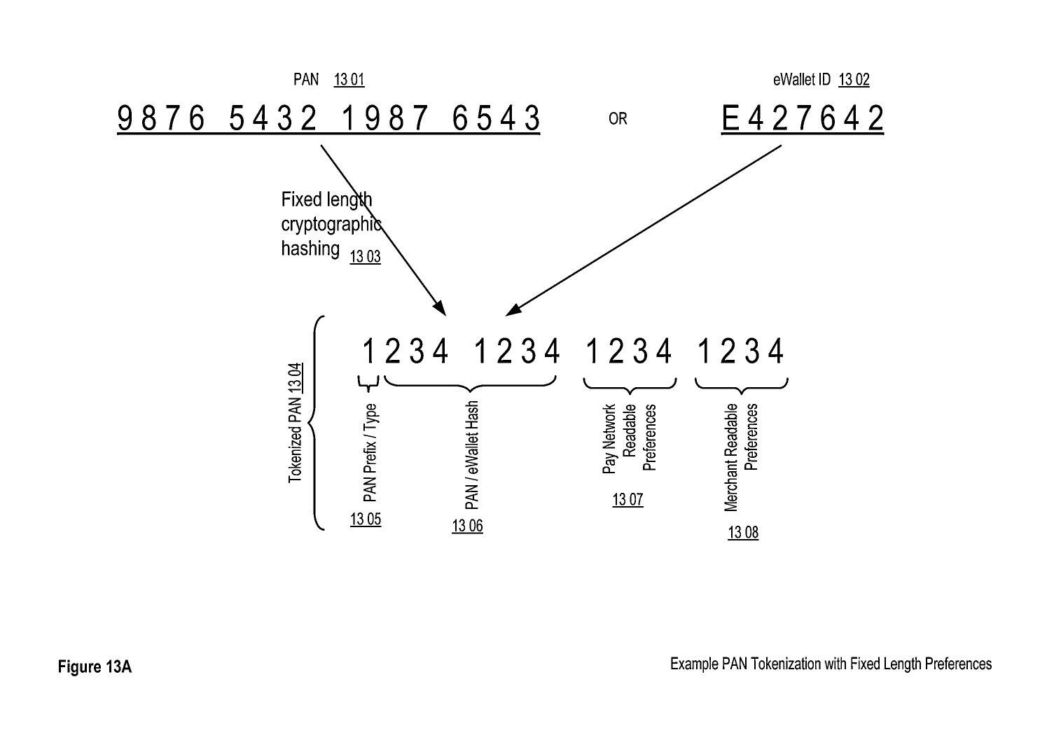

FIGS. 13A-B show block diagrams illustrating example PAN tokenization with fixed and variable length preferences, in some embodiments of the PTR. In one embodiment, a payment account number 1301, a virtual wallet identifier 1302, and/or the like may be encoded using a fixed length cryptographic hash 1303 (e.g., SHA-3, MD2, MD3, MD5, SHA-256, and/or the like) to fit in a designated slot length of a PAN template 1304, e.g., 1306. The PAN template may also contain a PAN type 1305 as well as portions representing consumer preferences that are readable by a pay network 1307 and portions representing consumer preferences that are readable by a merchant 1308. With respect to FIG. 13B, the portion of the PAN length devoted to representing an account number/virtual wallet account identifier (e.g., the hashed PAN) may be shortened, e.g., 1309, in order to accommodate more preferences, e.g., 1310. Depending upon the amount of time that a dynamic time limited PAN may need to be active, the amount of the PAN devoted to the account number may be reduced or increased, e.g., 1311, 1312, while still avoiding PAN collisions with other issued and active PAN's. For example, a PAN that is only valid for an hour may devote less space or slots to an account identifier because the number of unique hashes required by a payment network during the hour is less than the total possible account numbers.

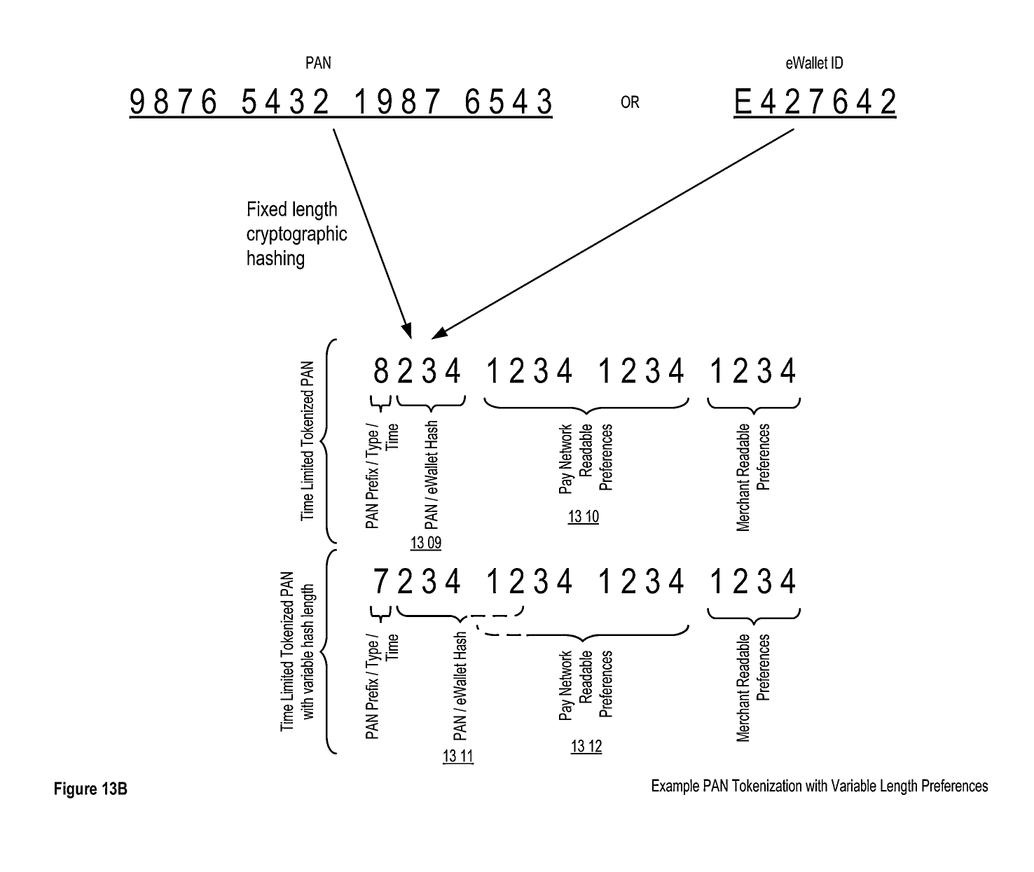

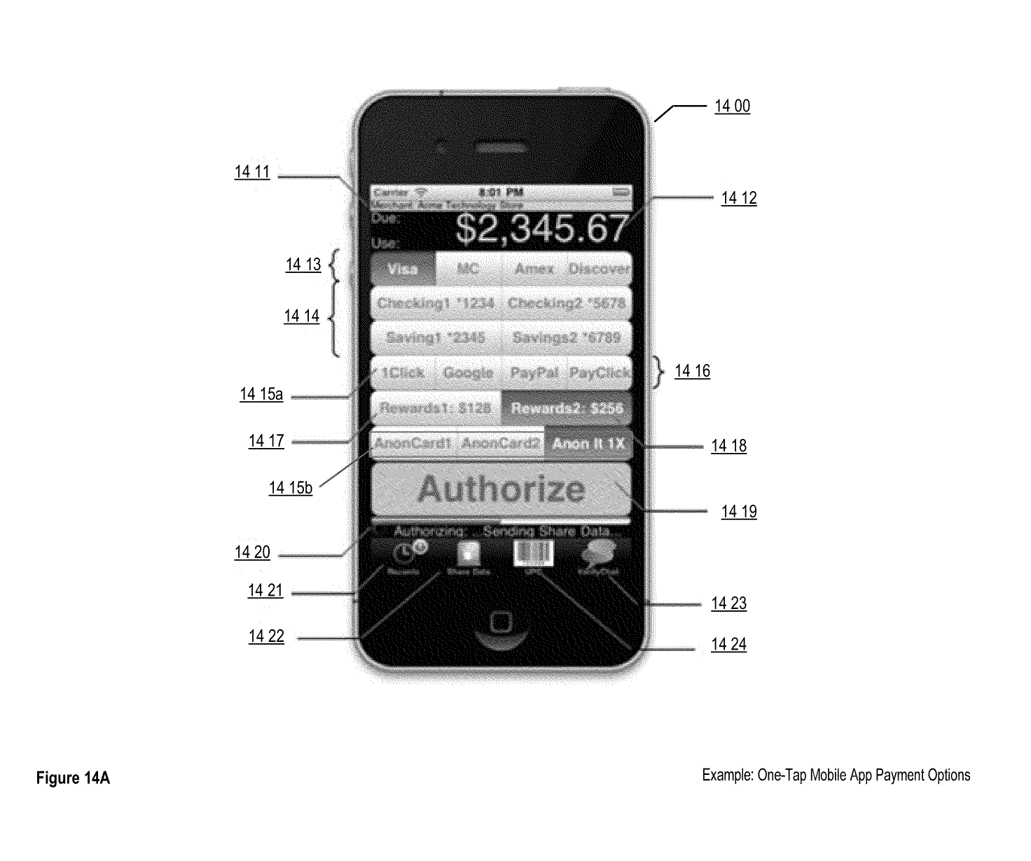

FIGS. 14A-B show user interface diagrams illustrating example aspects of dynamic user selection of virtual wallet transaction-related customizations in some embodiments of the PTR. With reference to FIG. 14A, in some implementations, app executing on a device 1400 of a user may include an app interface providing various virtual wallet customization features for the user. In some implementations, the app may include an indication of the location (e.g., name of the merchant store, geographical location, information about the aisle within the merchant store, etc.) of the user, e.g., 1411. The app may provide an indication of a pay amount due for the purchase of the product, e.g., 1412. In some implementations, the app may provide various options for the user to pay the amount for purchasing the product(s). For example, the app may utilize the GPS coordinates to determine the merchant store within the user is present, and direct the user to a website of the merchant. In some implementations, the PTR may provide an API for participating merchants directly to facilitate transaction processing. In some implementations, a merchant-branded PTR application may be developed with the PTR capabilities, which may directly connect the user into the merchant's transaction processing system. For example, the user may choose from a number of cards (e.g., credit cards, debit cards, prepaid cards, etc.) from various card providers, e.g., 1413. In some implementations, the app may provide the user the option to pay the purchase amount using funds included in a bank account of the user, e.g., a checking, savings, money market, current account, etc., e.g., 1414. In some implementations, the user may have set default options for which card, bank account, etc. to use for the purchase transactions via the app. In some implementations, such setting of default options may allow the user to initiate the purchase transaction via a single click, tap, swipe, and/or other remedial user input action, e.g., 1415. In some implementations, when the user utilizes such an option, the app may utilize the default settings of the user to initiate the purchase transaction. In some implementations, the app may allow the user to utilize other accounts (e.g., Google™ Checkout, Paypal™ account, etc.) to pay for the purchase transaction, e.g., 1416. In some implementations, the app may allow the user to utilize rewards points, airline miles, hotel points, electronic coupons, printed coupons (e.g., by capturing the printed coupons similar to the product identifier) etc., to pay for the purchase transaction, e.g., 1417-1418. In some implementations, the app may provide an option to provide express authorization before initiating the purchase transaction, e.g., 1419. In some implementations, the app may provide a progress indicator provide indication on the progress of the transaction after the user has selected an option to initiate the purchase transaction, e.g., 1420. In some implementations, the app may provide the user with historical information on the user's prior purchases via the app, e.g., 1421. In some implementations, the app may provide the user with an option to share information about the purchase (e.g., via email, SMS, wall posting on Facebook®, tweet on Twitter™, etc.) with other users, e.g., 1422. In some implementations the app may provide the user an option to display the product identification information captured by the client device (e.g., in order to show a customer service representative at the exit of a store the product information), e.g., 1424. In some implementations, the user, app, device and or PTR may encounter an error in the processing. In such scenarios, the user may be able to chat with a customer service representative (e.g., VerifyChat 1423) to resolve the difficulties in the purchase transaction procedure.

In some implementations, the user may select to conduct the transaction using a one-time anonymized credit card number, see e.g., 1415b. For example, the PTR may utilize a pre-designated anonymized set of card details (see, e.g., “AnonCard1,” “AnonCard2”). As another example, the PTR may generate, e.g., in real-time, a one-time anonymous set of card details to securely complete the purchase transaction (e.g., “Anon It 1X”). In such implementations, the app may automatically set the user profile settings such that the any personal identifying information of the user will not be provided to the merchant and/or other entities. In some implementations, the user may be required to enter a user name and password to enable the anonymization features.

With reference to FIG. 14B, in some implementations, the user may be able to view and/or modify the user profile and/or settings of the user. For example, the user may be able to view/modify a user name (e.g., 1431a-b), account number (e.g., 1432a-b), user security access code (e.g., 1433a-b), user pin (e.g., 1434a-b), user address (e.g., 1435a-b), social security number associated with the user (e.g., 1436a-b), current device GPS location (e.g., 1437a-b), user account of the merchant in whose store the user currently is (e.g., 1438a-b), the user's rewards accounts (e.g., 1439a-b), and/or the like. In some implementations, the user may be able to select which of the data fields and their associated values should be transmitted to facilitate the purchase transaction, thus providing enhanced data security for the user. For example, in the example illustration in FIG. 14B, the user has selected the name 1431a, account number 1432a, security code 1433a, merchant account ID 1438a and rewards account ID 1439a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the PTR with the GPS location of the user. Based on the GPS location of the user, the PTR may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information

### PTR Controller

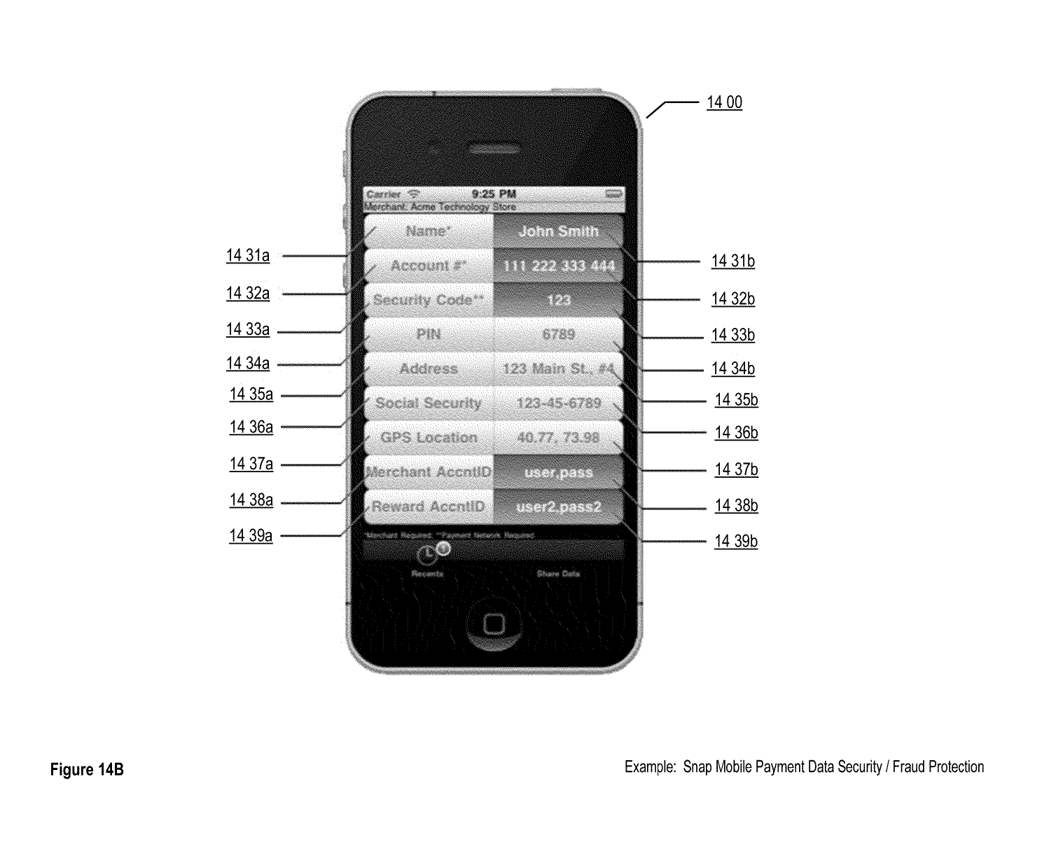

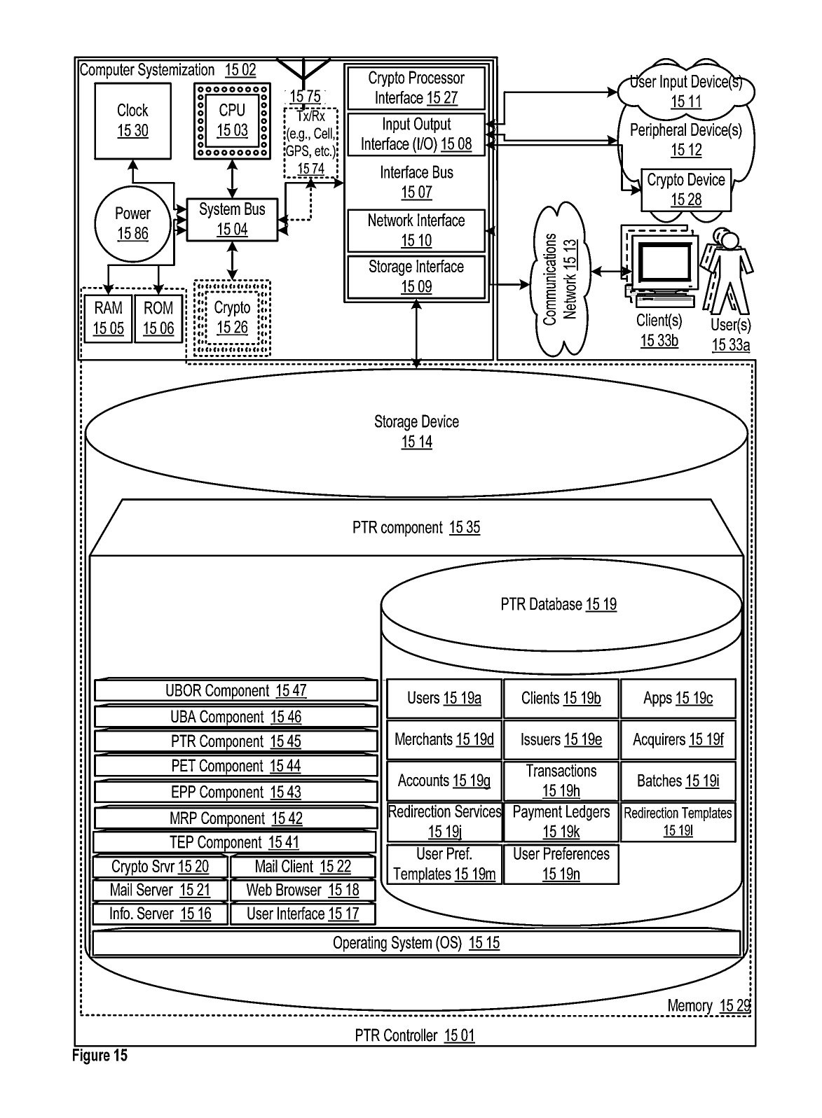

FIG. 15 shows a block diagram illustrating embodiments of a PTR controller. In this embodiment, the PTR controller 1501 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 1503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PTR controller 1501 may be connected to and/or communicate with entities such as, but not limited to: one or more users from user input devices 1511; peripheral devices 1512; an optional cryptographic processor device 1528; and/or a communications network 1513.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PTR controller 1501 may be based on computer systems that may comprise, but are not limited to, components such as: a computer systemization 1502 connected to memory 1529.

### Computer Systemization

A computer systemization 1502 may comprise a clock 1530, central processing unit (“CPU(s)” and/or “processor(s)” (these terms are used interchangeable throughout the disclosure unless noted to the contrary)) 1503, a memory 1529 (e.g., a read only memory (ROM) 1506, a random access memory (RAM) 1505, etc.), and/or an interface bus 1507, and most frequently, although not necessarily, are all interconnected and/or communicating through a system bus 1504 on one or more (mother)board(s) 1502 having conductive and/or otherwise transportive circuit pathways through which instructions (e.g., binary encoded signals) may travel to effectuate communications, operations, storage, etc. The computer systemization may be connected to a power source 1586; e.g., optionally the power source may be internal. Optionally, a cryptographic processor 1526 and/or transceivers (e.g., ICs) 1574 may be connected to the system bus. In another embodiment, the cryptographic processor and/or transceivers may be connected as either internal and/or external peripheral devices 1512 via the interface bus I/O. In turn, the transceivers may be connected to antenna(s) 1575, thereby effectuating wireless transmission and reception of various communication and/or sensor protocols; for example the antenna(s) may connect to: a Texas Instruments WiLink WL1283 transceiver chip (e.g., providing 802.1 in, Bluetooth 3.0, FM, global positioning system (GPS) (thereby allowing PTR controller to determine its location)); Broadcom BCM4329FKUBG transceiver chip (e.g., providing 802.11n, Bluetooth 2.1+ EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PTR controller and beyond through various interfaces. Should processing requirements dictate a greater amount speed and/or capacity, distributed processors (e.g., Distributed PTR), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the PTR may be achieved by implementing a microcontroller such as CAST's R8051XC2 microcontroller; Intel's MCS 51 (i.e., 8051 microcontroller); and/or the like. Also, to implement certain features of the PTR, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PTR component collection (distributed or otherwise) and/or features may be implemented via the microprocessor and/or via embedded components; e.g., via ASIC, coprocessor, DSP, FPGA, and/or the like. Alternately, some implementations of the PTR may be implemented with embedded components that are configured and used to achieve a variety of features or signal processing.

Depending on the particular implementation, the embedded components may include software solutions, hardware solutions, and/or some combination of both hardware/software solutions. For example, PTR features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PTR features. A hierarchy of programmable interconnects allow logic blocks to be interconnected as needed by the PTR system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the PTR may be developed on regular FPGAs and then migrated into a fixed version that more resembles ASIC implementations. Alternate or coordinating implementations may migrate PTR controller features to a final ASIC instead of or in addition to FPGAs. Depending on the implementation all of the aforementioned embedded components and microprocessors may be considered the “CPU” and/or “processor” for the PTR.

### Power Source

The power source 1586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1586 is connected to at least one of the interconnected subsequent components of the PTR thereby providing an electric current to all subsequent components. In one example, the power source 1586 is connected to the system bus component 1504. In an alternative embodiment, an outside power source 1586 is provided through a connection across the I/O 1508 interface. For example, a USB and/or IEEE 1394 connection carries both data and power across the connection and is therefore a suitable source of power.

### Interface Adapters

Interface bus(ses) 1507 may accept, connect, and/or communicate to a number of interface adapters, conventionally although not necessarily in the form of adapter cards, such as but not limited to: input output interfaces (I/O) 1508, storage interfaces 1509, network interfaces 1510, and/or the like. Optionally, cryptographic processor interfaces 1527 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1509 may accept, communicate, and/or connect to a number of storage devices such as, but not limited to: storage devices 1514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE)1394, fiber channel, Small Computer Systems Interface (SCSI), Universal Serial Bus (USB), and/or the like.

Network interfaces 1510 may accept, communicate, and/or connect to a communications network 1513. Through a communications network 1513, the PTR controller is accessible through remote clients 1533b (e.g., computers with web browsers) by users 1533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed PTR), architectures may similarly be employed to pool, load balance, and/or otherwise increase the communicative bandwidth required by the PTR controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1510 may be used to engage with various communications network types 1513. For example, multiple network interfaces may be employed to allow for the communication over broadcast, multicast, and/or unicast networks.

Input Output interfaces (I/O) 1508 may accept, communicate, and/or connect to user input devices 1511, peripheral devices 1512, cryptographic processor devices 1528, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1511 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1512 may be connected and/or communicate to I/O and/or other facilities of the like such as network interfaces, storage interfaces, directly to the interface bus, system bus, the CPU, and/or the like. Peripheral devices may be external, internal and/or part of the PTR controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the PTR controller may be embodied as an embedded, dedicated, and/or monitor-less (i.e., headless) device, wherein access would be provided over a network interface connection.

Cryptographic units such as, but not limited to, microcontrollers, processors 1526, interfaces 1527, and/or devices 1528 may be attached, and/or communicate with the PTR controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1529. However, memory is a fungible technology and resource, thus, any number of memory embodiments may be employed in lieu of or in concert with one another. It is to be understood that the PTR controller and/or a computer systemization may employ various forms of memory 1529. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1529 will include ROM 1506, RAM 1505, and a storage device 1514. A storage device 1514 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1529 may contain a collection of program and/or database components and/or data such as, but not limited to: operating system component(s) 1515 (operating system); information server component(s) 1516 (information server); user interface component(s) 1517 (user interface); Web browser component(s) 1518 (Web browser); database(s) 1519; mail server component(s) 1521; mail client component(s) 1522; cryptographic server component(s) 1520 (cryptographic server); the PTR component(s) 1535; TEP component 1541, MRP component 1542, EPP component 1543, PET component 1544, PTR component 1545, UBA component 1546, UBOR component 1547 and/or the like (i.e., collectively a component collection). These components may be stored and accessed from the storage devices and/or from storage devices accessible through an interface bus. Although non-conventional program components such as those in the component collection, typically, are stored in a local storage device 1514, they may also be loaded and/or stored in memory such as: peripheral devices, RAM, remote storage facilities through a communications network, ROM, various forms of memory, and/or the like.

### Operating System

The operating system component 1515 is an executable program component facilitating the operation of the PTR controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP/Win7 (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the PTR controller to communicate with other entities through a communications network 1513. Various communication protocols may be used by the PTR controller as a subcarrier transport mechanism for interaction, such as, but not limited to: multicast, TCP/IP, UDP, unicast, and/or the like.

### Information Server

An information server component 1516 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PTR controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PTR database 1519, operating systems, other program components, user interfaces, Web browsers, and/or the like.

Access to the PTR database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PTR. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PTR as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery UI, MooTools, Prototype, script.aculo.us, SWFObject, Yahoo! User Interface, any of which may be used and provide a baseline and means of accessing and displaying information graphically to users.

A user interface component 1517 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1518 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Firefox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the PTR enabled nodes. The combined application may be nugatory on systems employing standard Web browsers.

### Mail Server

A mail server component 1521 is a stored program component that is executed by a CPU 1503. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the PTR.

Access to the PTR mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1522 is a stored program component that is executed by a CPU 1503. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1520 is a stored program component that is executed by a CPU 1503, cryptographic processor 1526, cryptographic processor interface 1527, cryptographic processor device 1528, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the PTR may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the PTR component to engage in secure transactions if so desired. The cryptographic component facilitates the secure accessing of resources on the PTR and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The PTR Database

The PTR database component 1519 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the PTR database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the PTR database is implemented as a data-structure, the use of the PTR database 1519 may be integrated into another component such as the PTR component 1535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1519 includes several tables 1519a-n. A Users table 1519a may include fields such as, but not limited to: user_id, ssn, dob, first_name, last_name, age, state, address_firstline, address_secondline, zipcode, devices_list, contact_info, contact_type, alt contact_info, alt_contact_type, and/or the like. The Users table may support and/or track multiple entity accounts on a PTR. A Clients table 1519b may include fields such as, but not limited to: client_id, user_id client_ip, client_type, client_model, operating_system, os_version, app_installed_flag, and/or the like. An Apps table 1519c may include fields such as, but not limited to: app_id, app_name, app_type, OS_compatibilities_list, version, timestamp, developer_id, and/or the like. A Merchants table 1519d may include fields such as, but not limited to: merchant_id, merchant_name, provi merchant address, ip_address, mac_address, auth_key, port_num, security_settings_list, and/or the like. An Issuers table 1519e may include fields such as, but not limited to: issuer_id, issuer_name, issuer_address, ip_address, mac_address, auth_key, port_num, security_settings_list, and/or the like. An Acquirers table 1519f may include fields such as, but not limited to: acquirer_id, account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. An Accounts table 1519g may include fields such as, but not limited to: account_id, user_id, account_num, account_name, issuer_aquirer_flag, institution_name, and/or the like. A Transactions table 1519h may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 1519i may include fields such as, but not limited to: batch_id, transaction_id, merchant_id, issuer_id, acquirer_id, batch_amount, processing_start_date, processing_start_time, processing_end_date, processing_end_time, and/or the like. A Redirection Services table 1519j may include fields such as, but not limited to: redirection_services_id, user_preferences_id, redirection_template, user_id, account_id, last_used_datetime, and/or the like. A Payment Ledgers table 1519k may include fields such as, but not limited to: payment_ledgers_id, account_id, merchant_id, user_id, payment_amount, currency, date_transaction, time_transaction, and/or the like. A Redirection Templates table 1519l may include fields such as, but not limited to: redirection_template_id, redirection_services_id, user_id, template_name, template_header, template_body, template_footer, template_rules, template_permissions, and/or the like. A User Preference Templates table 1519m may include fields such as, but not limited to: user_preference_template_id, abstraction_template_id, template_name, template_header, template_body, template_footer, template_rules, template_permissions, template_user_access_permissions, and/or the like. A User Preferences table 1519n may include fields such as, but not limited to: user_preference_id, user_id, user_preference_template_id, preference_name, preference_type, preference_value, preference_valid_dates, preference_valid_times, last_used, and/or the like.

In one embodiment, the PTR database may interact with other database systems. For example, employing a distributed database system, queries and data access by search PTR component may treat the combination of the PTR database, an integrated data security layer database as a single database entity.

In one embodiment, user programs may contain various user interface primitives, which may serve to update the PTR. Also, various accounts may require custom database tables depending upon the environments and the types of clients the PTR may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1519a-n. The PTR may be configured to keep track of various settings, inputs, and parameters via database controllers.

The PTR database may communicate to and/or with other components in a component collection, including itself, and/or facilities of the like. Most frequently, the PTR database communicates with the PTR component, other program components, and/or the like. The database may contain, retain, and provide information regarding other nodes and data.

### The PTRs

The PTR component 1535 is a stored program component that is executed by a CPU. In one embodiment, the PTR component incorporates any and/or all combinations of the aspects of the PTR that was discussed in the previous figures. As such, the PTR affects accessing, obtaining and the provision of information, services, transactions, and/or the like across various communications networks. The features and embodiments of the PTR discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the PTR's features and facilities, and in many cases reduce the costs, energy consumption/requirements, and extend the life of PTR's underlying infrastructure; this has the added benefit of making the PTR more reliable. Similarly, many of the features and mechanisms are designed to be easier for users to use and access, thereby broadening the audience that may enjoy/employ and exploit the feature sets of the PTR; such ease of use also helps to increase the reliability of the PTR. In addition, the feature sets include heightened security as noted via the Cryptographic components 1520, 1526, 1528 and throughout, making access to the features and data more reliable and secure.

The PTR component may transform point-of-transaction abstraction inputs, and/or the like and use the PTR. In one embodiment, the PTR component 1535 takes inputs (e.g., tokenized preference input 302, tokenized preference pan request, tokenized purchase request 306, token purchase authorization request 308, post-purchase engagement request 315, virtual wallet purchase settings 811, purchase input 813, user point-of-transaction profile data 822, pre-generated user behavior pattern analysis data 828, merchant/offer data 831, issuer server data 841, user data 845a-n, batch data 859, and/or the like) etc., and transforms the inputs via various components (e.g., TEP Component 1541, MRP Component 1542, EPP Component 1543, PET Component 1545, UBA Component 1546, UBOR Component 1547 and/or the like), into outputs (e.g., tokenized preference response 305, tokenized purchase response 311, token purchase authorization response 310, post-purchase engagement response 316, purchase success output 312, real-time geo-sensitive product offer packet 834, card authorization request 839, authorization response 843a-n, transaction data 849, authorization success message 850-851, batch append data 853, purchase receipt 854, funds transfer message 873 and/or the like).

The PTR component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PTR server employs a cryptographic server to encrypt and decrypt communications. The PTR component may communicate to and/or with other components in a component collection, including itself, and/or facilities of the like. Most frequently, the PTR component communicates with the PTR database, operating systems, other program components, and/or the like. The PTR may contain, communicate, generate, obtain, and/or provide program component, system, user, and/or data communications, requests, and/or responses.

### Distributed PTRs

The structure and/or operation of any of the PTR node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PTR controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PTR controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
//set ip address and port to listen to for incoming data
$address = ‘192.168.0.100’;
$port = 255;
//create a server-side SSL socket, listen
//for/accept incoming communication
$sock = socket_create(AF_INET, SOCK_STREAM, 0);
socket_bind($sock, $address, $port)
    or die(‘Could not bind to address’);
socket_listen($sock);
$client = socket_accept($sock);
//read input data from client device in 1024 byte
//blocks until end of message
do {
        $input = “”;
        $input = socket_read($client, 1024);
        $data .= $input;
} while($input != “”);
// parse data to extract variables
$obj = json_decode($data, true);
// store input data in a database
mysql_connect(″10.1.1.1″,$srvr,$pass); // access database server
mysql_select(″CLIENT_DB.SQL″); // select database to append
mysql_query(“INSERT INTO UserTable (transmission) VALUES
($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.htmlhttp://publib.boulder.-
ibm.com/infocenter/tivihelp/v2r1/index.jsp?topic=/com.ibm.IBMDI.-
doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

In order to address various issues and advance the art, the entirety of this application for PTR (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a PTR individual and/or enterprise user, database configuration and/or relational model, data type, data transmission and/or network framework, syntax structure, and/or the like, various embodiments of the PTR, may be implemented that enable a great deal of flexibility and customization. For example, aspects of the PTR may be adapted for restaurant dining, online shopping, brick-and-mortar shopping, secured information processing, and/or the like. While various embodiments and discussions of the PTR have been directed to electronic purchase transactions, however, it is to be understood that the embodiments described herein may be readily configured and/or customized for a wide variety of other applications and/or implementations.

What is claimed is:

1. A point-of-transaction account feature redirection processor-implemented method, comprising:
obtaining a user preference indication package containing at least one user specified preference and a payment account identifier to be encoded as an account redirected feature identifier;
extracting at least one user preference value from the user preference indication package;
querying a redirected feature database for a user preference value template associated with the at least one user preference value;
encoding the at least one user preference value using the user preference value template to create at least one encoded user preference value;
querying a dynamic payment account template database for a dynamic payment account template that can represent at least one encoded user preference value;
generating a hashed payment account identifier using the payment account identifier;
applying the dynamic payment account template to the at least one encoded user preference value and the generated hashed payment account identifier to create the account redirected feature identifier; and
providing the account redirected feature identifier.

2. The method of claim 1, additionally comprising:
determining that there exists no dynamic payment account template that can represent the at least one encoded user preference value;
executing an encoded user preference value optimization manipulation; and
determining that there exists a dynamic payment account template that can represent the at least one encoded user preference value.

3. The method of claim 2, wherein the optimization manipulation is a combination of two or more at least one encoded user preference values.

4. The method of claim 2, wherein the optimization manipulation is the creation of a time limited payment account identifier.

5. The method of claim 4, wherein the time limited payment account identifier is substituted for the obtained payment account identifier.

6. The method of claim 2, wherein the optimization manipulation comprises:
determining a minimum required payment account identifier active time;
querying a collision prevention server for a maximum available payment account active time; and
determining a reduction in payment account space representation slots required by a time-limited account identifier.

7. The method of claim 6, additionally comprising:
receiving from the collision prevention server a plurality of available time-limited account identifier opportunities; and
selecting at least one time-limited account identifier opportunity.

8. The method of claim 6, additionally comprising:
making at least one payment account space representation slot available for representing an at least one encoded user preference value.

9. A point-of-transaction account feature redirection processor-implemented system, comprising:
means to obtain a user preference indication package containing at least one user specified preference and a payment account identifier to be encoded as an account redirected feature identifier;
means to extract at least one user preference value from the user preference indication package;
means to query a redirected feature database for a user preference value template associated with the at least one user preference value;
means to encode the at least one user preference value using the user preference value template to create at least one encoded user preference value;
means to query a dynamic payment account template database for a dynamic payment account template that can represent at least one encoded user preference value;
means to generate a hashed payment account identifier using the payment account identifier;
means to apply the dynamic payment account template to the at least one encoded user preference value and the generated hashed payment account identifier to create the account redirected feature identifier; and
means to provide the account redirected feature identifier.

10. The system of claim 9, additionally comprising:
means to determine that there exists no dynamic payment account template that can represent the at least one encoded user preference value;
means to execute an encoded user preference value optimization manipulation; and
means to determine that there exists a dynamic payment account template that can represent the at least one encoded user preference value.

11. The system of claim 10, wherein the optimization manipulation is a combination of two or more at least one encoded user preference values.

12. The system of claim 10, wherein the optimization manipulation is the creation of a time limited payment account identifier.

13. The system of claim 12, wherein the time limited payment account identifier is substituted for the obtained payment account identifier.

14. The system of claim 10, wherein the optimization manipulation comprises:
means to determine a minimum required payment account identifier active time;
means to query a collision prevention server for a maximum available payment account active time; and
means to determine a reduction in payment account space representation slots required by a time-limited account identifier.

15. The system of claim 14, additionally comprising:
means to receive from the collision prevention server a plurality of available time-limited account identifier opportunities; and
means to select at least one time-limited account identifier opportunity.

16. The system of claim 14, additionally comprising:
means to make at least one payment account space representation slot available for representing an at least one encoded user preference value.

17. A point-of-transaction account feature redirection apparatus, comprising:
a memory;
a processor disposed in communication with said memory, and configured to issue a plurality of processing instructions stored in the memory, wherein the processor issues instructions to:
obtain a user preference indication package containing at least one user specified preference and a payment account identifier to be encoded as an account redirected feature identifier;
extract at least one user preference value from the user preference indication package;
query a redirected feature database for a user preference value template associated with the at least one user preference value;
encode the at least one user preference value using the user preference value template to create at least one encoded user preference value;
query a dynamic payment account template database for a dynamic payment account template that can represent at least one encoded user preference value;
generate a hashed payment account identifier using the payment account identifier;
apply the dynamic payment account template to the at least one encoded user preference value and the generated hashed payment account identifier to create the account redirected feature identifier; and
provide the account redirected feature identifier.

18. The apparatus of claim 17, additionally comprising instructions to:
determine that there exists no dynamic payment account template that can represent the at least one encoded user preference value;
execute an encoded user preference value optimization manipulation; and
determine that there exists a dynamic payment account template that can represent the at least one encoded user preference value.

19. The apparatus of claim 18, wherein the optimization manipulation is the creation of a time limited payment account identifier.

20. A non-transitory medium storing point-of-transaction account feature redirection processor-implemented instructions to:
obtain a user preference indication package containing at least one user specified preference and a payment account identifier to be encoded as an account redirected feature identifier;
extract at least one user preference value from the user preference indication package;
query a redirected feature database for a user preference value template associated with the at least one user preference value;
encode the at least one user preference value using the user preference value template to create at least one encoded user preference value;
query a dynamic payment account template database for a dynamic payment account template that can represent at least one encoded user preference value;
generate a hashed payment account identifier using the payment account identifier;
apply the dynamic payment account template to the at least one encoded user preference value and the generated hashed payment account identifier to create the account redirected feature identifier; and
provide the account redirected feature identifier.
